(19) United States
(12) Patent Application Publication
(10) Pub. No.: US 2025/0343724 A1
(43) Pub. Date: Nov. 6, 2025

(54) ELECTRONIC DEVICE AND METHOD FOR PERFORMING NETWORK QUALITY MANAGEMENT

(71) Applicant: Samsung Electronics Co., Ltd., Suwon-si (KR)

(72) Inventors: Sangkyu PARK, Suwon-si (KR); Aman TIWARI, Suwon-si (KR)

(21) Appl. No.: 19/271,345

(22) Filed: Jul. 16, 2025

Related U.S. Application Data
(63) Continuation of application No. PCT/KR2023/020017, filed on Dec. 6, 2023.

(30) Foreign Application Priority Data
Jan. 16, 2023 (KR) 10-2023-0006398
Feb. 21, 2023 (KR) 10-2023-0023221
Mar. 9, 2023 (KR) 10-2023-0031103

(51) Int. Cl. H04L 41/0631

(52) U.S. Cl. CPC H04L 41/0631

(57) ABSTRACT

A method performed by an electronic device is provided. The method includes identifying based on a value for a key performance indicator (KPI) related to quality of a network being out of a designated range, an anomaly of the KPI, identifying a time interval related to a timing in which the anomaly of the KPI has occurred, identifying, in the time interval, a plurality of alarms obtained through at least one network element (NE) for the network, identifying first correlation information between the KPI and the plurality of alarms identified using trained data related to the KPI and second correlation information between the KPI and the plurality of alarms identified according to the timing and occurrence timings of the plurality of alarms, and identifying, based on the first correlation information and the second correlation information, an alarm causing the anomaly of the KPI among the plurality of alarms.

### CROSS-REFERENCE TO RELATED APPLICATION(S)

This application is a continuation application, claiming priority under 35 U.S.C. § 365(c), of an International application No. PCT/KR2023/020017, filed on Dec. 6, 2023, which is based on and claims the benefit of a Korean patent application number 10-2023-0006398, filed on Jan. 16, 2023, in the Korean Intellectual Property Office, and of a Korean patent application number 10-2023-0023221, filed on Feb. 21, 2023, in the Korean Intellectual Property Office, and of a Korean patent application number 10-2023-0031103, filed on Mar. 9, 2023, in the Korean Intellectual Property Office, the disclosure of each of which is incorporated by reference herein in its entirety.

### BACKGROUND

### 1. Field

The disclosure relates to a wireless communication system. More particularly, the disclosure relates to an electronic device and method for performing network quality management in the wireless communication system.

### 2. Description of Related Art

A key performance indicator (KPI) may be defined to indicate quality of a network. A wireless communication system may determine whether an anomaly has occurred in the network through a value related to the KPI. As the value of the KPI is managed in the wireless communication system, the quality of the network may be improved.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device and method for performing network quality management in the wireless communication system.

Additional aspects will be set forth in part in the description which follows and, in part, will be apparent from the description, or may be learned by practice of the presented embodiments.

In accordance with an aspect of the disclosure, a method performed by an electronic device is provided. The method includes identifying, based on a value for a key performance indicator (KPI) related to quality of a network being out of a designated range, an anomaly of the KPI, identifying a time interval related to a timing in which the anomaly of the KPI has occurred, identifying, in the time interval, a plurality of alarms obtained through at least one network element (NE) for the network, identifying first correlation information between the KPI and the plurality of alarms identified using trained data related to the KPI and second correlation information between the KPI and the plurality of alarms identified according to the timing and occurrence timings of the plurality of alarms, and identifying, based on the first correlation information and the second correlation information, an alarm causing the anomaly of the KPI among the plurality of alarms.

In accordance with another aspect of the disclosure, an electronic device is provided. The electronic device includes memory, comprising one or more storage media, storing instructions, a transceiver, and one or more processors communicatively coupled to the transceiver and the memory, wherein the instructions, when executed by the one or more processors individually or collectively cause the electronic device to identify, based on a value for a key performance indicator (KPI) related to quality of a network being out of a designated range, an anomaly of the KPI, identify a time interval related to a timing in which the anomaly of the KPI has occurred, identify, in the time interval, a plurality of alarms obtained through at least one network element (NE) for the network, identify first correlation information between the KPI and the plurality of alarms identified using trained data related to the KPI and second correlation information between the KPI and the plurality of alarms identified according to the timing and occurrence timings of the plurality of alarms, and identify, based on the first correlation information and the second correlation information, an alarm causing the anomaly of the KPI among the plurality of alarms.

In accordance with another aspect of the disclosure, one or more non-transitory computer-readable storage media storing one or more computer programs, wherein the one or more programs include computer-executable instructions that, when executed by one or more processors of an electronic device individually or collectively, cause the electronic device to perform operations are provided. The operations include identifying, based on a value for a key performance indicator (KPI) related to quality of a network being out of a designated range, an anomaly of the KPI, identifying a time interval related to a timing in which the anomaly of the KPI has occurred, identifying, in the time interval, a plurality of alarms obtained through at least one network element (NE) for the network, identifying first correlation information between the KPI and the plurality of alarms identified using trained data related to the KPI and second correlation information between the KPI and the plurality of alarms identified according to the timing and occurrence timings of the plurality of alarms, and identifying, based on the first correlation information and the second correlation information, an alarm causing the anomaly of the KPI among the plurality of alarms.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a wireless communication system according to an embodiment of the disclosure;

FIG. 2 illustrates a system including an electronic device for obtaining information on at least one cell according to an embodiment of the disclosure;

FIG. 3 illustrates an example of a graph indicating a change of KPI according to an event according to an embodiment of the disclosure;

FIG. 4 illustrates an example of a system for analyzing an alarm causing deterioration and/or an anomaly of KPI according to an embodiment of the disclosure;

FIG. 5 illustrates an example of a system for training an association rule between an alarm and KPI according to an embodiment of the disclosure;

FIG. 6 indicates an operation of an electronic device for identifying an impacting alarm according to an embodiment of the disclosure;

FIG. 7 illustrates an example of an operation of an electronic device for training an association rule between an alarm and KPI according to an embodiment of the disclosure;

FIG. 8 illustrates an example of an operation of an electronic device for identifying an alarm causing an anomaly of KPI according to an embodiment of the disclosure;

FIGS. 9A and 9B illustrate an example of a preprocessing process of data on alarms that have occurred according to various embodiments of the disclosure;

FIGS. 10A and 10B illustrate an example of an operation for identifying a second candidate alarm group based on a time-series correlation according to various embodiments of the disclosure;

FIG. 11 illustrates a graph indicating a change of KPI according to an alarm according to an embodiment of the disclosure;

FIG. 12 illustrates an interface for displaying a graph indicating a change of KPI according to an alarm according to an embodiment of the disclosure;

FIGS. 13A, 13B, 13C, and 13D illustrate an example of an interface for displaying a portion of candidate alarms related to a deterioration of KPI according to various embodiments of the disclosure;

FIG. 14 illustrates a flowchart with respect to an operation of an electronic device according to an embodiment of the disclosure; and

FIG. 15 illustrates an example of a functional configuration of an electronic device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In various embodiments of the disclosure described below, a hardware approach will be described as an example. However, since the various embodiments of the disclosure include technology that uses both hardware and software, the various embodiments of the disclosure do not exclude a software-based approach.

A term referring to a signal (e.g., a signal, information, a symbol, a message, signaling, a reference signal (RS), or data), a term referring to a resource (e.g., a symbol, a slot, a subframe, a radio frame, a subcarrier, a resource element (RE), a bandwidth part (RB), or an opportunity), a term for a calculation state (e.g., a step, an operation, or a procedure), a term referring to data (e.g., a packet, a user stream, information, a bit, a symbol, or a codeword), a term referring to a channel, a term referring to a network entity, a term referring to a device, and the like that are used in the following description are exemplified for convenience of explanation. Therefore, the disclosure is not limited to the terms described below, and another term having an equivalent technical meaning may be used.

In addition, in the disclosure, the term ‘greater than’ or ‘less than’ may be used to determine whether a particular condition is satisfied or fulfilled, but this is only a description to express an example and does not exclude description of ‘greater than or equal to’ or ‘less than or equal to’. A condition described as ‘greater than or equal to’ may be replaced with ‘greater than’, a condition described as ‘less than or equal to’ may be replaced with ‘less than’, and a condition described as ‘ greater than or equal to and less than’ may be replaced with ‘greater than and less than or equal to’. In addition, hereinafter, ‘A’ to ‘B’ refers to at least one of elements from A (including A) to B (including B). Hereinafter, ‘C’ and/or ‘D’ means including at least one of ‘C’ or ‘D’, that is, {‘C’, ‘D’, and ‘C’ and ‘D’}.

The disclosure describes various embodiments using terms used in some communication standards (e.g., a 3rd Generation Partnership Project (3GPP), an extensible radio access network (xRAN)), and an open-radio access network (O-RAN)), but this is only an example for explanation. Various embodiments of the disclosure may be easily modified and applied in another communication system.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

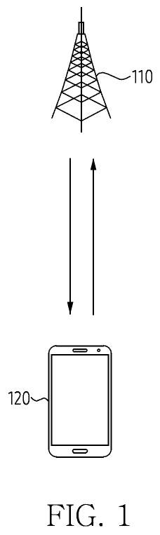

FIG. 1 illustrates a wireless communication system according to an embodiment of the disclosure.

Referring to FIG. 1, FIG. 1 exemplifies a base station 110 and a terminal 120 as a portion of nodes using a wireless channel in the wireless communication system. Although FIG. 1 illustrates only one base station, the wireless communication system may further include another base station identical to or similar to the base station 110.

The base station 110 is a network infrastructure for providing wireless access to the terminal 120. The base station 110 has coverage defined based on a distance capable of transmitting a signal. In addition to the base station, the base station 110 may be referred to as an “access point (AP), an “eNode B (eNB), a “5th generation node,” a “next generation node B (gNB)”, a “wireless point,” a “transmission/reception point (TRP),” or another term having an equivalent technical meaning thereto.

The terminal 120 is a device used by a user, and communicates with the base station 110 through the wireless channel. A link from the base station 110 toward the terminal 120 is referred to as downlink (DL), and a link from the terminal 120 toward the base station 110 is referred to as uplink (UL). In addition, although not illustrated in FIG. 1, the terminal 120 and another terminal may communicate with each other through the wireless channel. In this case, a device-to-device link (D2D) between the terminal 120 and the other terminal is referred to as a sidelink, and the sidelink may be used interchangeably with an PC5 interface. In some other embodiments, the terminal 120 may be operated without user involvement. According to an embodiment, the terminal 120, which is a device that performs machine type communication (MTC), may not be carried by the user. In addition, according to an embodiment, the terminal 120 may be a narrowband (NB)-internet of things (IoT) device.

In addition to a terminal, the terminal 120 may be referred to as “user equipment (UE)”, “customer premises equipment (CPE)”, a “mobile station”, a “subscriber station”, a “remote terminal”, a “wireless terminal”, an “electronic device”, or another term having a technical meaning equivalent thereto.

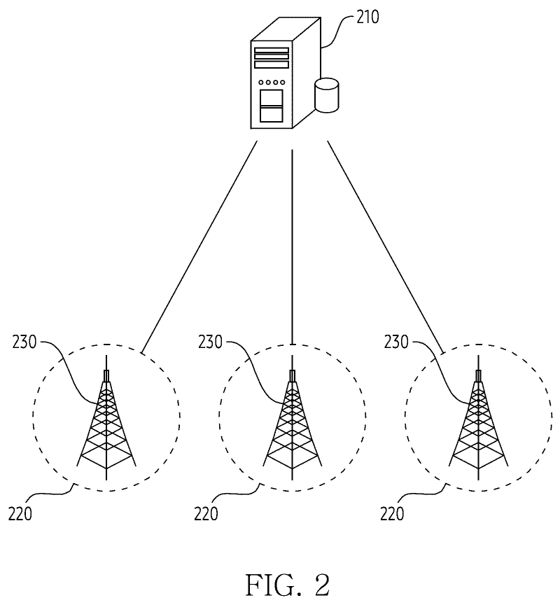

FIG. 2 illustrates a system including an electronic device for obtaining information on at least one cell according to an embodiment of the disclosure.

Referring to FIG. 2, an electronic device 210 may be used to obtain information on at least one cell. For example, the at least one cell may include a cells 220. The cells 220 may be configured by base stations 230. The cell 220-2 may be configured by a base station 230-2. The cell 220-3 may be configured by a base station 230-3.

The electronic device 210 may be connected with at least one base station (e.g., the base station 230-1 to the base station 230-2) corresponding to the at least one cell. For example, one base station may be configured with one or more network elements (NEs). As an example, the one or more NEs may include a distributed unit (DU) and/or a radio unit (RU).

For example, in a case that an anomaly occurs in a network, the one or more NEs may respectively provide an alarm for the anomaly in the network to the electronic device 210. The electronic device 210 may identify the alarm provided from the one or more NEs. The electronic device 210 may store the alarm provided from the one or more NEs. As an example, an alarm may mean information on CPU usage, information on a mismatch of a common public radio port (CPRI) port, and/or information on a function fail of a component related to NE.

For example, the electronic device 210 may identify a change of a key performance indicator (KPI). The KPI may refer to one of performance indicators related to quality of the network. As an example, the KPI may mean a value for a throughput, a value for a cell capacity, a value for a handover success rate, a value for packet loss, a value for a transmission capacity, and/or a value for a session setup failure rate.

According to an embodiment, an anomaly and/or deterioration of the KPI (hereinafter, an anomaly of the KPI) may occur according to use of the network. The electronic device 210 may identify an alarm causing the anomaly of the KPI. In the following specification, a technical feature for identifying the alarm causing the anomaly of the KPI among a plurality of alarms occurring during the use of the network will be described.

Referring to FIG. 2, it is described that the electronic device 210 may perform both an operation of storing the alarm obtained from the one or more NEs and an operation of identifying the alarm causing the anomaly of the KPI, but is not limited thereto. The electronic device 210 may be configured with one or more devices (or components) distinguished according to a function. For example, the electronic device 210 may include a device for storing the change of the KPI according to a time, a device for storing the alarm obtained from the one or more NEs, and a device (e.g., a device for a fault management (FM) system) for identifying the alarm causing the anomaly of the KPI. Each of the above-described devices may be configured as one device (e.g., the electronic device 210), or may be configured as independent devices (or functional blocks).

According to an embodiment, data obtained (or identified) from the fault management (FM) system monitoring a mobile communication network may be used to identify (or determine) a cause of malfunction or performance degradation occurring within the network. For example, a cause (or an underlying cause) related to a network problem may be analyzed and identified through alarm data occurring by a physical device and/or a logical unit (or block).

In the following specification, a technical feature for network problem analysis may be described. Specifically, a method and a system for analyzing a cause of deterioration of network quality may be described.

In a case that the deterioration and/or the anomaly of the key performance indicator (KPI) of the mobile communication network occurs, it is necessary to analyze a cause from various perspectives for troubleshooting. For example, in a case that the deterioration and/or the anomaly of the key performance indicator (KPI) of the mobile communication network occurs, the cause of the deterioration and/or the anomaly of the KPI should be identified in order to deal with the deterioration and/or the anomaly of the KPI. For example, abnormal behavior due to a system or equipment failure, user distribution in the network, traffic increase or decrease in the network, and/or a change in operational parameter may cause the deterioration and/or the anomaly of the KPI.

Hereinafter, an electronic device and a method for identifying whether the deterioration and/or the anomaly of the KPI have occurred due to the system and/or equipment failure using alarm data may be described. In addition, the electronic device and the method for identifying (or specifying) at least one alarm related to the deterioration and/or the anomaly of the KPI among a plurality of occurring alarms may be described.

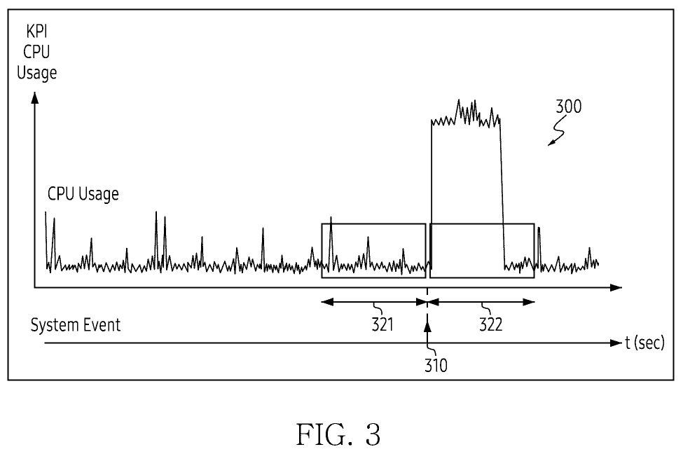

FIG. 3 illustrates an example of a graph indicating a change of KPI according to an event according to an embodiment of the disclosure.

Referring to FIG. 3, an electronic device 210 may identify (or evaluate) a correlation between an alarm identified based on an event sequence form and the KPI identified based on a time-series form. For example, the electronic device 210 may obtain a T-score based on a change of the KPI during a time interval before an occurrence of an alarm (or an event) and a change of the KPI during a time interval after the occurrence of the alarm (or the event). The electronic device 210 may identify the correlation between the alarm and the KPI based on the T-score.

For example, a graph 300 indicates a change of central processing unit (CPU) usage according to a time. An x-axis of the graph 300 indicates a time, and a unit is a second [s]. A y-axis of the graph 300 indicates CPU usage, and a unit is a percent [%].

At a timing 310, an alarm may occur. The electronic device 210 may identify values (or a change of CPU usage) for CPU usage within a time interval 321, which is before the alarm occurs. The electronic device 210 may identify values (or a change of CPU usage) for CPU usage within a time interval 322, which is after the alarm occurs. The electronic device 210 may obtain (or identify) a T-score based on the values for the CPU usage within the time interval 321 and the values for the CPU usage within the time interval 322. As an example, the T-score identified based on the values for the CPU usage within the time interval 321 and the values for the CPU usage within the time interval 322 may be set as illustrated in the following equation.

$${t}_{score} = \frac{{μ}_{1} - {μ}_{2}}{\sqrt{\frac{{σ}_{1}^{2} + {σ}_{2}^{2}}{n}}} \qquad Equation l$$

Referring to Equation 1, μ₁ is an average of values for the CPU usage within the time interval 321. μ₂ is an average of the values for the CPU usage within the time interval 322. σ₁ is a standard deviation of the values for the CPU usage within the time interval 321. σ₂ is a standard deviation of the values for the CPU usage within the time interval 322. n is the number of the alarm occurrence.

However, it may be difficult to view an occurring alarm (or a cause of the alarm occurrence) just because the alarm with a statistical relationship has occurred as the cause of the anomaly and/or the deterioration of the KPI.

For example, since a target NE (or cell) of alarm data and KPI data may be inconsistent, the cell affected by the actual alarm may be a portion of cells in which the alarm has occurred. Therefore, it may be difficult to view the occurring alarm (or the cause of the alarm occurrence) as the cause of the anomaly and/or the deterioration of the KPI.

For example, in a case that duration of the alarm is short, a cause (or fault) related to the alarm may not affect the KPI. For example, when the KPI is identified as an average value per hour, it may be released within a few seconds after the alarm has occurred. In this case, the occurring alarm may not affect the KPI. Therefore, it may be difficult to view the occurring alarm (or the cause of the alarm occurrence) as the cause of the anomaly and/or the deterioration of the KPI.

According to an embodiment, the electronic device 210 may identify a correlation between alarms for the plurality of occurring alarms and identify a representative alarm (or a parent alarm). For example, based on arbitrary two alarms included in a cluster that is a set of alarms that have occurred during the same time interval, the electronic device 210 may identify probabilities of an occurrence for the two alarms. The electronic device 210 may identify the correlation between the alarms based on the probabilities of the occurrence for the two alarms. However, the KPI and the alarm may have different measurement methods, recording methods, and/or data formats. Therefore, in a case that the embodiment is applied, the correlation between the KPI and the alarm may not be obtained. For example, the alarm data may be recorded based on an alarm occurrence event and/or release event. Therefore, according to the embodiment, an alarm related to the cause of the deterioration and/or the anomaly of the KPI that changes according to a time measured (or recorded) at a designated period may not be identified. In addition, since the correlation between the alarms is obtained based on whether the alarm occurs and its probability in the embodiment, a correlation between the KPI and the alarms may not be obtained even if the embodiment is applied.

Hereinafter, in order to solve the problems of the above-described embodiments, a technical feature for identifying the cause of the deterioration and/or the anomaly of the KPI may be described, based on a correlation between KPI of a network entity (NE) (or a cell) trained (or found) from data in the past and an alarm, and similarity of a temporal pattern between KPI time-series data that is actually obtained (or observed) and an alarm event.

According to an embodiment, in order to identify the cause (or an alarm for the cause) of the deterioration and/or the anomaly of the KPI, the similarity of the temporal pattern as well as a statistical relationship between the alarm identified (or found) from past data and the KPI may be further considered. Accordingly, reliability of a detection result of the alarm for the cause of the deterioration and/or the anomaly of the KPI may be improved. In addition, the electronic device according to the embodiment may visually display the detection result of the alarm for the deterioration and/or the anomaly of the KPI through a graphical user interface (GUI).

For example, association rule training may be used to identify a statistical correlation between the KPI and the alarm. Accordingly, not only a combination of alarms occurring together when the anomaly of the KPI occurs, but also an event related to an alarm occurrence that is highly related to an occurrence of the deterioration and/or the anomaly of the KPI and a state of the event (e.g., duration of the event) may be identified as an association rule. As an example, a correlation between information indicating an occurrence of an alarm 1, an occurrence of an alarm 2, and duration (e.g., 30 seconds) of the alarm 2, and the KPI (or the anomaly of the KPI) may be identified.

According to the above-described embodiment, it is possible to identify whether there is the alarm for a cause that has affected the occurrence of the anomaly of the KPI (or the deterioration of the KPI). In addition, the alarm for the cause that has affected the occurrence of the deterioration and/or the anomaly of the KPI may be identified. Accordingly, a procedure for troubleshooting may be reduced, and the overall network performance may be improved.

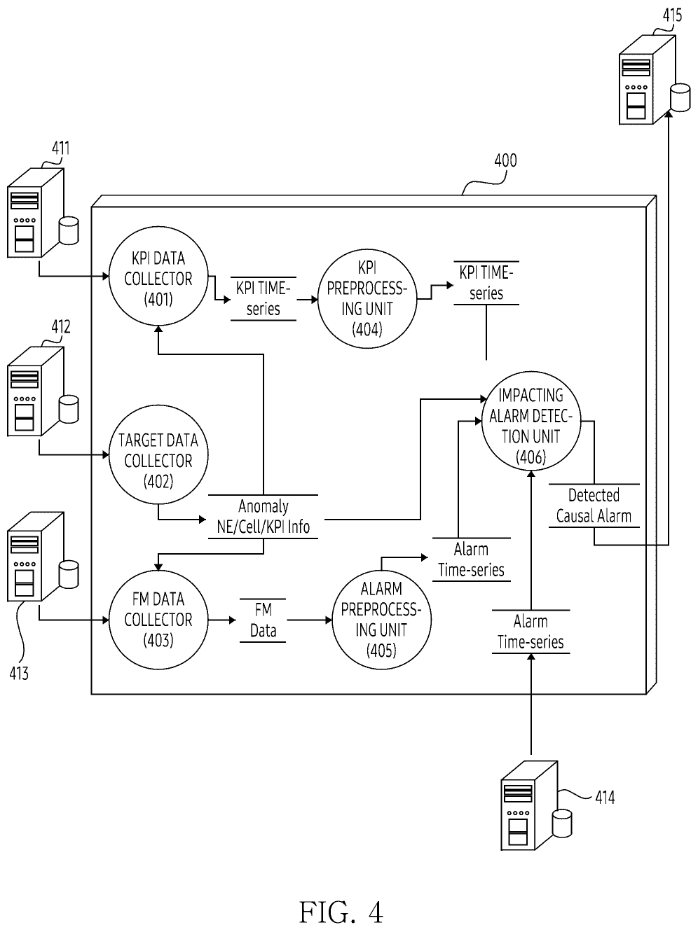

FIG. 4 illustrates an example of a system for analyzing an alarm causing deterioration and/or an anomaly of KPI according to an embodiment of the disclosure. An electronic device 400 of FIG. 4 may be related to the electronic device 210 of FIGS. 2 to 3. For example, the electronic device 400 of FIG. 4 may correspond to the electronic device 210 of FIGS. 2 and 3.

Referring to FIG. 4, the electronic device 400 may include one or more functional blocks. For example, the electronic device 400 may include at least one of a KPI data collector 401, a target data collector 402, an FM data collector 403, a KPI preprocessing unit 404, an alarm preprocessing unit 405, and an impacting alarm detection unit 406.

The KPI data collector 401 may be used to obtain data on a change of the KPI according to a time, related to a NE (or a cell) set as an analysis target, from a device 411 for storing data on the KPI (or performance management (PM)).

The KPI preprocessing unit 404 may be used to generate KPI time-series data on the NE (or the cell) set as the analysis target by using the data on the change of the KPI according to a time related to the NE (or the cell) set as the analysis target. In addition, the KPI preprocessing unit 404 may be used to perform additional preprocessing (e.g., a missing value identification operation) on the KPI time-series data.

The target data collector 402 may be used to obtain data on an anomaly of the KPI, related to the NE (or the cell) set as the analysis target, from a device 412 for storing data on the anomaly of the KPI. For example, the data on the anomaly of the KPI may include at least one of data on the NE (or the cell) in which the anomaly of the KPI has occurred and data on a time interval in which the anomaly of the KPI has occurred.

The fault management (FM) data collector 403 may be used to obtain data on FM related to the NE (or the cell) set as the analysis target from a device 413 for storing the data on the FM. For example, the FM data collector 403 may be used to obtain data on at least one alarm related to the NE (or the cell) set as the analysis target.

The alarm preprocessing unit 405 may be used to generate an itemset by preprocessing (or converting) FM data set based on occurrence and clear (or termination) of an event. For example, the itemset may be obtained within a designated interval for time-series correlation analysis. The itemset may include time-series alarm data and information on an alarm occurrence feature (e.g., whether an alarm occurred, duration of the alarm, and the number of occurrences of the alarm) for detecting an antecedent related to an association rule with the time-series alarm data in the designated interval.

The impacting alarm detection unit 406 may be used to determine at least one alarm that affects KPI set as the analysis target, based on a time-series correlation related to the KPI set as the analysis target and an association rule related to the KPI, from among alarms occurring for the NE (or the cell, the KPI, or the designated interval) set as the analysis target. For example, data on the association rule related to the KPI set as the analysis target may be obtained from a device 414 for storing the association rule related to the KPI. For example, information on the at least one alarm that affects the KPI set as the analysis target may be transmitted to a device 415 for displaying the alarm and the KPI through a graphical user interface (GUI).

At least some of the above-described devices 411 to 415 may be included in the electronic device 400. According to an embodiment, at least some of functions of the device 411 to 415 may be performed in the electronic device 400.

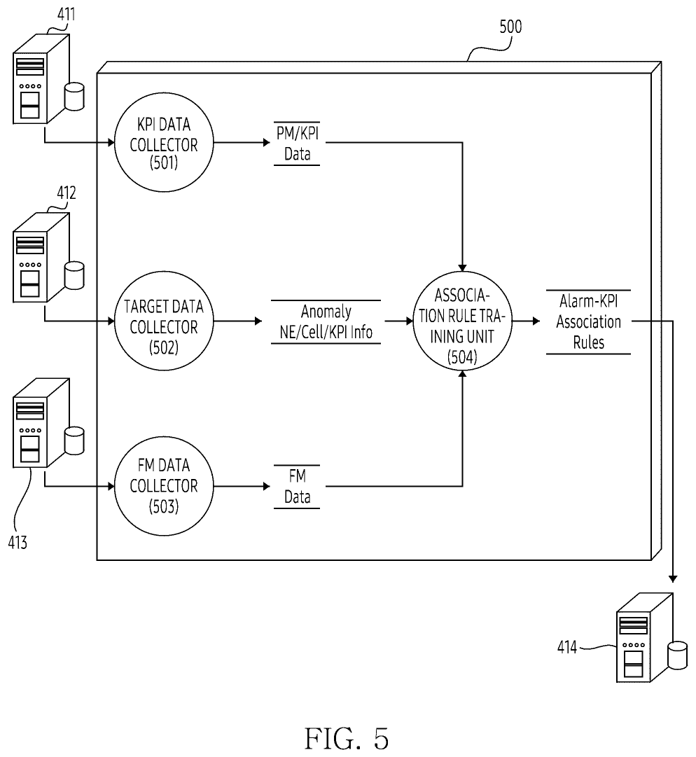

FIG. 5 illustrates an example of a system for training an association rule between an alarm and KPI according to an embodiment of the disclosure. An electronic device 500 of FIG. 5 may be related to the electronic device 210 of FIGS. 2 and 3 or the electronic device 400 of FIG. 4. For example, the electronic device 500 of FIG. 5 may correspond to the electronic device 210 of FIGS. 2 and 3 or the electronic device 400 of FIG. 4. According to an embodiment, the electronic device 500 of FIG. 5 may be distinguished from the electronic device 400 of FIG. 4.

Referring to FIG. 5, the electronic device 500 may include one or more functional blocks. For example, the electronic device 500 may include at least one of a KPI data collector 501, a target data collector 502, an FM data collector 503, and an association rule training unit 504.

The KPI data collector 501 may be used to obtain data on a change of KPI according to a time, related to a NE (or a cell) set as an analysis target, from a device 411 for storing data on the KPI (or performance management (PM)). For example, the KPI data collector 501 may correspond to the KPI data collector 401 of FIG. 4.

The target data collector 502 may be used to obtain data on an anomaly in the KPI, related to the NE (or cell) set as the analysis target, from a device 412 for storing data on the anomaly of the KPI. For example, the data on the anomaly of the KPI may include at least one of data on the NE (or the cell) in which the anomaly of the KPI has occurred and data on a time interval in which the anomaly of the KPI has occurred. For example, the target data collector 502 may correspond to the target data collector 402 of FIG. 4.

The fault management (FM) data collector 503 may be used to obtain data on FM related to the NE (or the cell) set as the analysis target from a device 413 for storing the data on the FM. For example, the FM data collector 503 may be used to obtain data on at least one alarm related to the NE (or the cell) set as the analysis target. For example, the FM data collector 503 may correspond to the FM data collector 403 of FIG. 4.

The association rule training unit 504 may be used to train (or discover) an association rule (or a statistical relationship) between the alarm and the KPI based on the data on the at least one alarm and the data on the KPI, related to the NE (or the cell) set as the analysis target. For example, data on the association rule (or association rule related to the KPI) between the alarm and the KPI obtained through an association rule training unit 504 may be stored in a device 414 for storing the association rule related to the KPI.

Hereinafter, an operation of the electronic device 500 for identifying an impacting alarm that has affected an occurrence of the anomaly of the KPI will be described. It is described that embodiments described below are performed in the electronic device 500, but it is not limited thereto. The following embodiments may be also performed in the electronic device 400.

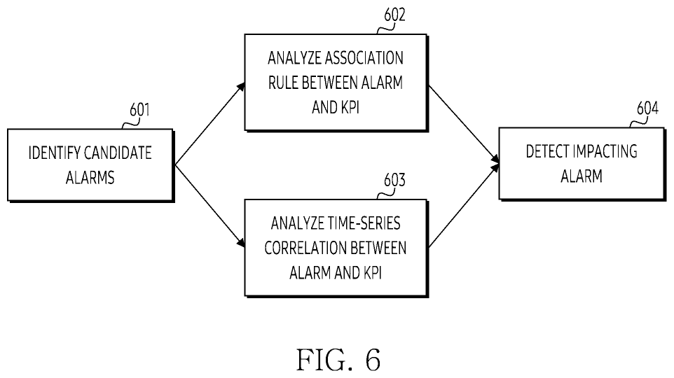

FIG. 6 indicates an operation of an electronic device for identifying an impacting alarm according to an embodiment of the disclosure.

Referring to FIG. 6, in operation 601, an electronic device 500 (or a processor of the electronic device 500) may identify candidate alarms. For example, the electronic device 500 may identify, based on an occurrence of an anomaly of KPI (or a deterioration of the KPI), candidate alarms related to the occurrence of the anomaly of the KPI. The electronic device 500 may identify occurring candidate alarms along with the anomaly of the KPI. The electronic device 500 may identify occurring candidate alarms in a time interval between before a designated time interval and/or after the designated time interval based on a timing at which the anomaly of the KPI has occurred.

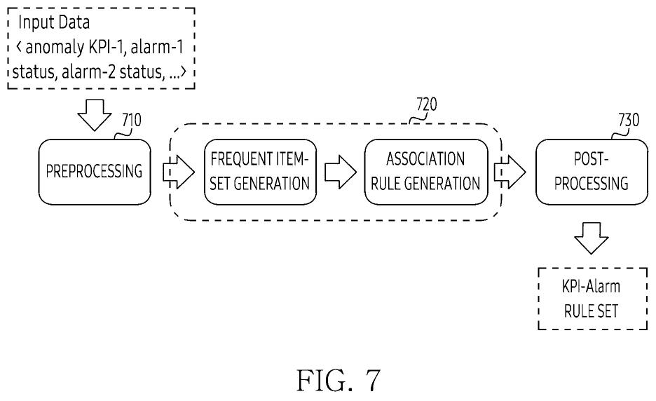

In operation 602, the electronic device 500 may analyze an association rule between an alarm and KPI. For example, the electronic device 500 may analyze (or train) the association rule between the alarm and the KPI based on time-series data of the KPI and the alarms occurring in at least one NE related to the electronic device 500. For example, the electronic device 500 may use the association rule between the alarm and the KPI to identify an impacting alarm related to the anomaly of the KPI. For example, the impacting alarm may mean an alarm causing the anomaly of the KPI. A specific example of operation 602 will be described later in FIG. 7.

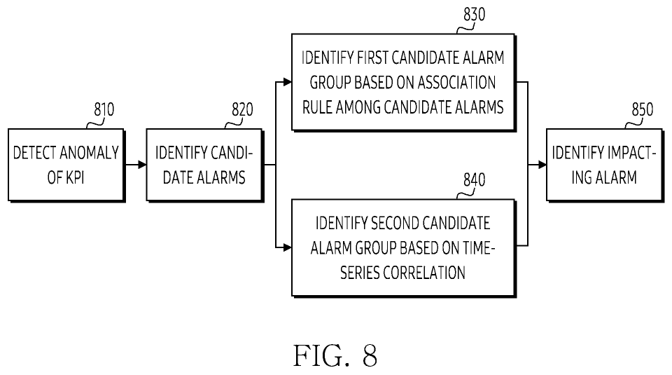

In operation 603, the electronic device 500 may analyze a time-series correlation between the alarm and the KPI. For example, the electronic device 500 may analyze (or train) the time-series correlation between the alarm and the KPI based on the time-series data of the KPI and the alarms occurring in the at least one NE related to the electronic device 500. For example, the electronic device 500 may use the time-series correlation between the alarm and the KPI to identify the impacting alarm related to the anomaly of the KPI. A specific example of operation 603 will be described later in FIG. 8.

In operation 604, the electronic device 500 may detect the impacting alarm. For example, the electronic device 500 may detect the impacting alarm that affects the anomaly pf the KPI among the candidate alarms related to the anomaly of the KPI. For example, the electronic device 500 may identify (or detect) the impacting alarm based on the association rule between the alarm and the KPI and the time-series correlation between the alarm and the KPI.

FIG. 7 illustrates an example of an operation of an electronic device for training an association rule between an alarm and KPI according to an embodiment of the disclosure.

Referring to FIG. 7, in operation 710, an electronic device 500 (or a processor of the electronic device 500) may perform preprocessing based on input data. For example, the electronic device 500 may perform preprocessing to generate an itemset indicating a state of an anomaly of KPI and/or an alarm for each of arbitrary NE (or cell, interval).

For example, the input data may include information on the anomaly of the KPI, information on a state of an alarm 1, and/or information on a state of an alarm 2. The information on the state of the alarm 1 may include information on a timing at which the alarm 1 has occurred and/or information on a time at which the alarm 1 has been maintained. The information on the state of the alarm 2 may include information on a timing at which the alarm 2 has occurred and/or information on a time at which the alarm 2 has been maintained.

For example, the itemset indicating the state of the anomaly of the KPI and/or the alarm for each of the arbitrary NE (or cell, interval) may be configured as shown in the following table.

TABLE 1

| [‘CELL_TOTAL_ERAB_DROP_RATE′,′mme-communication- | |
|---|---|
| fail_Critical′,′nbr-enb-communication-fail_Major′,′service-off_Critical′,′ump | |
| memory-threshold-exceeded_Critical′,′ump | memory-threshold- |
| exceeded_Major′,′ump | memory-threshold- |

exceeded_Critical::PERSISTENCY>30s′]

Referring to Table 1, ‘CELL_TOTAL_ERAB_DROP_RATE’ may be an example of the KPI. ‘ump memory-threshold-exceeded_Critical’ may be an example of the alarm. ‘ump memory-threshold-exceeded_Critical::PERSISTENCY>30s’ may be an example of a state of ‘ump memory-threshold-exceeded_Critical’. In Table 1, a drop rate of total evolved universal mobile telecommunications system terrestrial radio access network radio access bearer (ERAB) of a cell may be set as the KPI. For example, candidate alarms according to the total ERAB drop rate of the cell may include ‘ump memory-threshold-exceeded_Major’ and ‘ump memory-threshold-exceeded_Critical’. ‘ump memory-threshold-exceeded_Critical::PERSISTENCY>30s’ may indicate that ‘ump memory-threshold-exceeded_Critical’ lasted more than 30 seconds.

In operation 720, the electronic device 500 may perform association rule mining. For example, the electronic device 500 may perform association rule mining based on generating a frequent itemset and generating an association rule. For example, the electronic device 500 may extract the association rule based on all itemset sets generated for a plurality of NEs (or cells, time intervals).

In operation 730, the electronic device 500 may perform post-processing based on performing association rule mining. The electronic device 500 may perform post-processing by filtering an association rule set. For example, in the association rule set, an antecedent may be set as an item related to the alarm, and a consequent may be set as an item of the anomaly of the KPI.

The electronic device 500 may obtain a ruleset between the alarm and the KPI based on post-processing. For example, the electronic device 500 may perform post-processing so that the consequent includes only the item related to the alarm in the obtained ruleset.

For example, the ruleset obtained based on post-processing may be set as shown in the following table.

TABLE 2

| Rule ID | antecedents | consequents | support | confidence | Lift |
|---|---|---|---|---|---|
| 30 | [‘ump cpu-load- | KPI1_anomaly | 0.003 | 0.69 | 22.26 |
| | thrshhold- | | | | |
| | exceeded_Critical’] | | | | |
| 31 | [‘ump cpu-load- | KPI2_anomaly | 0.003 | 0.59 | 18.98 |
| | thrshhold- | | | | |
| | exceeded_Major’] | | | | |
| 32 | [‘ecp cpri-port- | KPI3_anomaly | 0.005 | 0.36 | 9.53 |
| | mismatch_Major’] | | | | |

. . .

Referring to Table 2, Rule ID means an ID for the association rule. Antecedents means an alarm set as the antecedent. Consequences means the anomaly of the KPI set as the consequent. Support means an occurrence rate of an association rule set as antecedents and consequents among all association rules. Confidence means a probability of an occurrence of the consequents according to the antecedents. Lift means a degree to which a probability of the occurrence of the consequents increases with an occurrence of the antecedents. It may mean that a correlation between the antecedents and the consequents is larger as the lift is higher.

FIG. 8 illustrates an example of an operation of an electronic device for identifying an alarm causing an anomaly of KPI according to an embodiment of the disclosure.

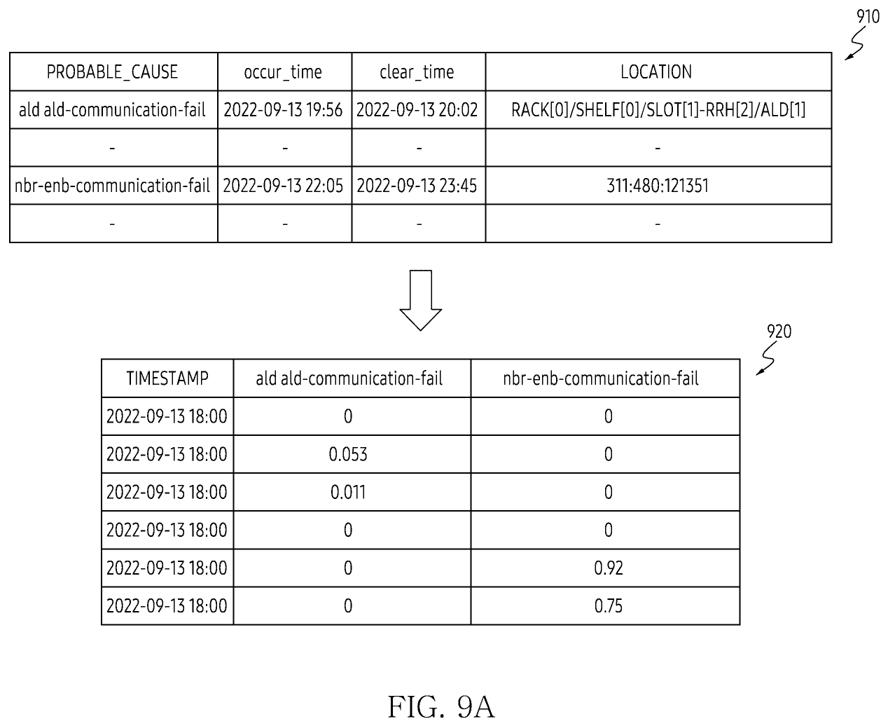

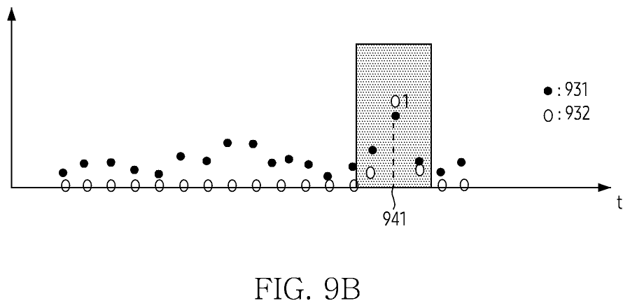

FIGS. 9A and 9B illustrate an example of a preprocessing process of data on alarms that have occurred according to various embodiments of the disclosure.

Referring to FIG. 8, an electronic device 500 may identify an alarm (or an impacting alarm) causing an anomaly of KPI (or a deterioration of the KPI) based on performing operations 810 to 850.

In operation 810, the electronic device 500 may detect the anomaly of the KPI. For example, the electronic device 500 may detect (or identify) the anomaly of the KPI after training an association rule between the alarm and the KPI according to operations 710 to 730 of FIG. 7.

In operation 820, the electronic device 500 may identify candidate alarms. The electronic device 500 may obtain (or collect) data on the KPI and data on the alarm, and identify the candidate alarms based on the data on the KPI and the data on the alarm.

For example, the electronic device 500 may identify NE (or a cell, a KPI, or a time interval) set as an analysis target. As an example, the electronic device 500 may identify at least one alarm occurring in a designated time interval including a timing at which the anomaly of the KPI has occurred as candidate alarms. As an example, the electronic device 500 may identify the NE (or the cell) related to the KPI in which the anomaly has occurred. The electronic device 500 may identify the candidate alarms by identifying alarms related to the identified NE (or the cell).

For example, the electronic device 500 may preprocess the data on the KPI and the data on the alarm. As an example, the data on the alarm may be obtained from the device 413 illustrated in FIG. 5.

Referring to FIG. 9A, the data on the alarm may be configured like data 910. The data 910 may be configured based on an occur/clear event sequence of the alarm. In the data 910, a ‘PROBABLE CAUSE’ field means a name of the alarm. In the data 910, an ‘occur time’ field means a time when the alarm starts. In the data 910, a ‘clear time’ field means a time when the alarm ends. In the data 910, a ‘location’ field means a location (or a point) where the alarm has occurred. The electronic device 500 may obtain (or generate) data 920 by preprocessing the data 910.

The data 920 obtained (or generated) by preprocessing the data 910 may be configured based on a time-series. The data 920 may be configured to indicate an occurrence rate of an alarm according to a time interval. Alarm_active_ratio may be identified as shown in the following equation.

$$Alarm\_active {\_ratio}_{i} = \frac{{\sum }_{n = 0}^{{N}_{i}} \{ min ( {t}_{n}^{clear} - {t}_{i}^{start} ) - max ( {t}_{n}^{occur} - {t}_{i}^{end} ) \}}{T} \qquad Equation 2$$

In Equation 2, i indicates a time slot index. n indicates an index of an alive alarm occurring during the time slot i.

$${t}_{n}^{occur}$$

means an occurrence time of the n-th alarm.

$${t}_{n}^{clear}$$

means a clear time of the n-th alarm.

$${t}_{i}^{start}$$

means a start time of the time slot i.

$${t}_{i}^{end}$$

means an end time of the time slot i. T means a time interval (e.g., 1 hour).

According to Equation 2, in the data 920, it may indicate that a ‘nbr-enb-communication-fail’ alarm was maintained for 3.18 (=60×0.053) of 1 hour from 19:00 to 20:00 on Sep. 13, 2022.

According to an embodiment, an alarm occurrence rate according to a time interval and KPI according to a time may be configured as shown in a graph 931 and a graph 932 of FIG. 9B.

Referring to FIG. 9B, the graph 931 indicates a change of KPI according to a time. In the graph 931, a horizontal axis indicates a time, and a vertical axis indicates a value for the KPI. The graph 932 indicates an alarm occurrence rate according to a time. In the graph 932, a horizontal axis indicates a time, and a vertical axis indicates an alarm occurrence rate in a time interval corresponding to the time. For example, at a timing 941, an alarm occurrence rate may be set as 1. Setting the alarm occurrence rate as 1 at the timing 941 may mean that the alarm has been maintained (or has occurred) throughout an entire time interval including the timing 941.

As described above, the electronic device 500 may identify the alarm occurrence rate according to a time by preprocessing the data on the alarm. The electronic device 500 may identify the alarm occurrence rate according to a time in order to perform time-series correlation analysis with the KPI.

Referring back to FIG. 8, in operation 830, the electronic device 500 may identify a first candidate alarm group based on the association rule. For example, the electronic device 500 may identify the first candidate alarm group based on the association rule between the trained alarm and KPI according to operations 710 to 730 of FIG. 7. For example, the electronic device 500 may identify the first candidate alarm group by identifying candidate alarms that are in a statistical relationship with the anomaly of the KPI.

For example, the electronic device 500 may identify the first candidate alarm group related to the anomaly of the KPI based on data on the association rule between the trained alarm and KPI. The electronic device 500 may identify the first candidate alarm group among the candidate alarms identified according to operation 820. The candidate alarms included in the first candidate alarm group may be related to the anomaly of the KPI.

For example, the electronic device 500 may identify whether there is an association rule related to the anomaly of the KPI and the candidate alarms among an association rule set between the trained alarm and KPI. The electronic device 500 may exclude alarms without the association rule from the first candidate alarm group. For example, the electronic device 500 may determine a priority of each of the candidate alarms included in the first candidate alarm group based on at least one of confidence and/or lift, which are indicators of the association rule.

For example, the first candidate alarm group may be configured as shown in the following table.

TABLE 3

| NE_ID | CNUM | DATE | KPI | matched_rules | top_rule | top_rule_lift | IMPACTING_ALARMS |
|---|---|---|---|---|---|---|---|
| ENB_185 | 3 | 2022 Nov. 8 | PDCP_PACKET_LOSS_RATE | | | | |
| ENB_185 | 1 | 2022 Nov. 8 | DL_RESIDUAL_BLER | R_61\|R_62\| | R_61 | 8.68 | rrh low- |
| | | | | R_63\|R_64 | | | gain_Major |
| ENB_113 | 24 | 2022 Nov. 8 | S1_HO_FAIL_RATE | | | | |
| ENB_113 | 2 | 2022 Nov. 8 | X2_HO_FAIL_RATE | R_49 | R_49 | 8.34 | nbr-enb- |
| | | | | | | | communication- |
| | | | | | | | fail_Major |
| ENB_242 | 24 | 2022 Nov. 8 | S1_HO_FAIL_RATE | | | | |

Referring to Table 3, a ‘NE_ID’ field indicates an ID of NE. A ‘CNUM’ field indicates a cell number. A ‘DATE’ field indicates a time when the anomaly of the KPI has occurred. A ‘KPI’ field indicates the KPI in which the anomaly has occurred. A ‘matched_rules’ field indicates a number (or an index) of an association rule related to the KPI in which the anomaly has occurred. A ‘top_rule’ field indicates the most relevant association rule based on a designated antecedent (e.g., confidence). A ‘top_rule_lift’ field indicates the lift of the association rule of the ‘top_rule’ field. A ‘IMPACTING_ALARMS’ field indicates an alarm (or an impacting alarm) causing the deterioration of the KPI identified in operation 830.

In operation 840, the electronic device 500 may identify a second candidate alarm group based on a time-series correlation. The electronic device 500 may identify (or calculate) a time-series correlation of the KPI and each of the candidate alarms. The electronic device 500 may identify the second candidate alarm group based on the time-series correlation. For example, the electronic device 500 may identify the second candidate alarm group as the time-series correlation identifies candidate alarms that meet a designated antecedent.

For example, the electronic device 500 may identify a time-series correlation between each of the candidate alarms and the KPI in which the anomaly has occurred. The electronic device 500 may identify a cross-correlation between a time-series vector x related to the alarm and a time-series vector h related to the KPI delayed by n samples. The cross-correlation between the vector x and the vector h may be identified based on the following equation.

$${R}_{x h} [ n ] = {\sum }_{k = 0}^{K} x [ k ] h [ n + k ] \qquad Equation 3$$

Referring to Equation 3, Rₓₕ[n] means the cross-correlation between the vector x and the vector h. K denotes the number of time-series samples determined according to a target interval (e.g., 1 day or 7 days).

For example, the electronic device 500 may set n values as candidates within a designated range. The electronic device 500 may identify an n value in which a cross-correlation is maximized among the n values (e.g., −1, 0, 1) set as the candidates. The electronic device 500 may identify a cross-correlation value of the alarm and the KPI obtained base on the n value in which the cross-correlation is maximized as a time-series correlation value of the alarm and the KPI. As an example, in a case that a maximum value of the cross-correlation value of the time-series vector h related to the KPI delayed by the time-series vector x related to the alarm and the n sample is obtained as the maximum value at n=0, and the obtained maximum value is greater than or equal to a reference value, the electronic device 500 may identify that a change (or anomaly) of the KPI according to the alarm appears without delay. As an example, when the maximum value of the cross-correlation value of the time-series vector h related to the KPI delayed by the time-series vector x related to the alarm and the n sample is obtained as the maximum value at n=M (or n=−M), and the obtained maximum value is greater than or equal to the reference value, the electronic device 500 may identify that the change (or anomaly) of the KPI according to the alarm appears after (or before) an M sample.

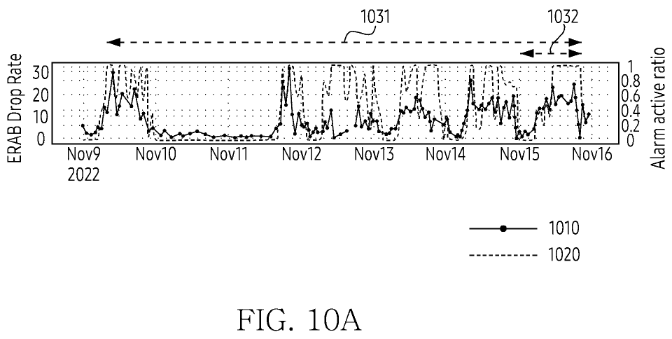

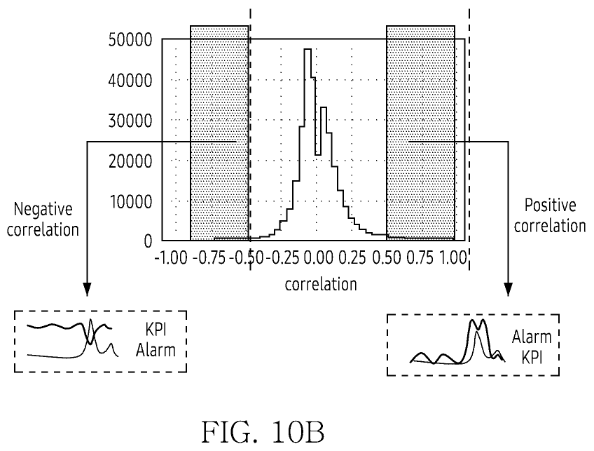

A specific operation of the electronic device 500 for identifying a time-series correlation between the alarm and the KPI according to operation 840 will be described later in FIGS. 10A and 10B.

In operation 850, the electronic device 500 may identify an impacting alarm. For example, the electronic device 500 may identify an impacting alarm causing the anomaly of the KPI. For example, the electronic device 500 may identify at least one impacting alarm causing the anomaly of the KPI.

For example, in operation 830, the electronic device 500 may identify the first candidate alarm set based on the association rule. According to operation 840, the electronic device 500 may identify the second candidate alarm set based on the time-series correlation. The electronic device 500 may identify an alarm (or at least one alarm) included in both the first candidate alarm set and the second candidate alarm set as the impacting alarm (or the at least one impacting alarm). According to an embodiment, the electronic device 500 may identify the impacting alarm by excluding an alarm generally occurring among the at least one alarm included in both the first candidate alarm set and the second candidate alarm set.

According to an embodiment, some of operations 810 to 850 described above may be omitted. According to an embodiment, another operation may be added between operations 810 to 850 described above. According to an embodiment, at least a portion of operations 810 to 850 may be simultaneously performed. According to an embodiment, an order of operations 810 to 850 may be changed. For example, the electronic device 500 may identify the first candidate alarm set among the candidate alarms based on operation 830. The electronic device 500 may identify the impacting alarm among the alarms included in the first candidate alarms based on operation 840.

FIGS. 10A and 10B illustrate an example of an operation for identifying a second candidate alarm group based on a time-series correlation according to various embodiments of the disclosure.

Referring to FIG. 10A, an electronic device 500 may identify a change of KPI according to a time based on data on the KPI obtained from the device 411 illustrated in FIG. 5. The electronic device 500 may identify an alarm occurrence rate according to a time based on data on the alarm obtained from the device 413 illustrated in FIG. 5.

For example, a graph 1010 indicates the change of the KPI (‘ERAB Drop Rate’) according to a time. A horizontal axis of the graph 1010 indicates a time (or a date). A vertical axis (left) of the graph 1010 indicates a value (unit: percent (%)) for ‘ERAB Drop Rate’.

A graph 1020 indicates an occurrence rate of an alarm (‘aldald-communication-fail_Major’) according to a time. A horizontal axis of the graph 1020 indicates a time (or a date). A vertical axis (right) of the graph 1020 indicates an alarm active ratio.

The electronic device 500 may set a time interval for identifying a time-series correlation between the alarm and the KPI. For example, the electronic device 500 may set a time interval 1031 for identifying a long-term correlation. As an example, the time interval 1031 may be set as 7 days. For example, the electronic device 500 may set a time interval 1032 for identifying a short-term correlation. As an example, the time interval 1032 may be set as 1 day.

The electronic device 500 may identify a time-series correlation between the alarm and the KPI in a designated time interval. The electronic device 500 may identify a cross-correlation value of a time-series vector x for the alarm and the time-series vector h for the KPI delayed by an n sample. The electronic device 500 may identify a maximum value of the cross-correlation value as the time-series correlation (hereinafter, referred to as a correlation value) between the alarm and the KPI.

Referring to FIG. 10B, FIG. 10B illustrates a distribution of the time-series correlation between the KPI and the alarm. The electronic device 500 may identify that the time-series correlation between the KPI and the alarm is high in an interval in which the correlation is greater than or equal to a first value (e.g., 0.5) or less than a second value (e.g., −0.5).

According to a type of the KPI, a standard for determining that a temporal pattern is similar may be changed. For example, in a case that a value of the KPI becomes smaller than a reference value, an anomaly of the KPI may be detected. In this case, the alarm and the KPI may have a negative correlation. The electronic device 500 may determine that the temporal pattern between the alarm and the KPI is similar as the correlation value decreases. For example, in a case that a value of the KPI becomes greater than the reference value, the anomaly of the KPI may be detected. In this case, the alarm and the KPI may have a positive correlation. The electronic device 500 may determine that the temporal pattern between the alarm and the KPI is similar as the correlation value increases. For example, the electronic device 500 may determine that a temporal pattern between ‘RRC_CONNECTION_DROP_RATE’ and the alarm is similar as a correlation value of ‘RRC_CONNECTION_DROP_RATE’ that is an example of the KPI and the alarm increases. For example, the electronic device 500 may determine that a temporal pattern between ‘DL-AVERAGE_ASIGNED_MCS’ and the alarm is similar as a correlation value of ‘DL-AVERAGE_ASIGNED_MCS’ that is an example of the KPI and the alarm decreases.

According to an embodiment, whether the temporal pattern between the alarm and the KPI is similar may be determined (or judged) according to the following standard.

For example, in a case that the alarm and the KPI have a negative correlation, the electronic device 500 may identify whether the temporal pattern between the alarm and the KPI is similar based on identifying whether the correlation value between the alarm and the KPI is less than a threshold value. In a case that the alarm and the KPI have a positive correlation, the electronic device 500 may identify whether the temporal pattern between the alarm and the KPI is similar based on identifying whether the correlation value between the alarm and the KPI is less than the threshold value.

For example, the electronic device 500 may identify that the temporal pattern between the alarm and the KPI is similar, based on the correlation value between the alarm and the KPI being included in a reference range (e.g., a range in an upper X % range or in a lower X % range) based on correlation statistics obtained from past data.

For example, the electronic device 500 may obtain a Z score based on the correlation value between the alarm and the KPI, and the correlation statistics (e.g., a mean or a standard deviation (std)) obtained from the past data. For example, in a case that the alarm and the KPI have a positive correlation, the electronic device 500 may identify that the temporal pattern between the alarm and the KPI is similar based on the Z score exceeding the threshold value. For example, in a case that the alarm and the KPI have a negative correlation, the electronic device 500 may identify that the temporal pattern between the alarm and the KPI is similar based on the Z score being less than the threshold value.

For example, the electronic device 500 may identify that the temporal pattern between the alarm and the KPI is similar based on the correlation between the KPI and the alarm corresponding to a target correlation direction identified according to the type of the KPI.

According to an embodiment, the electronic device 500 may visualize and display candidate alarms related to the anomaly of the KPI. For example, the electronic device 500 may visualize and display the candidate alarms related to the anomaly of the KPI using a display included in the electronic device 500 or a display connected to the electronic device 500. Hereinafter, an operation of the electronic device 500 for the electronic device 500 to display a graph indicating the change of the KPI according to a time and a graph indicating an alarm occurrence according to a time using the display may be described.

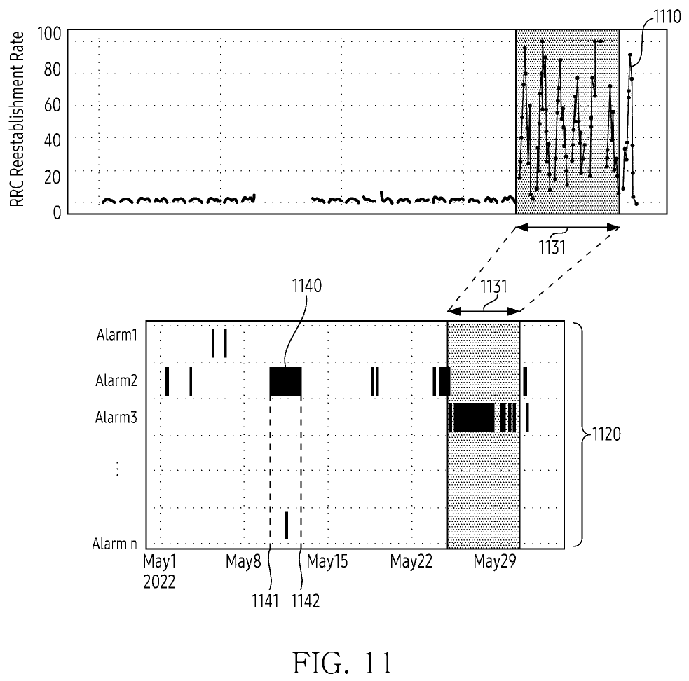

FIG. 11 illustrates a graph indicating a change of KPI according to an alarm according to an embodiment of the disclosure.

Referring to FIG. 11, an electronic device 500 may obtain data on an alarm and data on KPI. For example, the electronic device 500 may obtain data indicating a change of the KPI according to a time. The electronic device 500 may obtain data on an alarm occurrence according to a time. An example of the data on the alarm occurrence according to a time may be configured as shown in the following table.

TABLE 4

| Probable cause | Severity | occur_time | clear_time | Location |
|---|---|---|---|---|
| . . . | . . . | . . . | . . . | . . . |
| ald ald- | Major | 2022 May 24 | 2022 May 24 | RACK[0]/SHELF[0]/SLOT[1]- |
| communication- | | 23:36 | 23:42 | RRH[3]/ALD[2] |
| fail | | | | |
| rrh | Major | 2022 May 25 | 2022 May 25 | RACK[0]/SHELF[0]/SLOT[1]- |
| communication- | | 0:27 | 0:34 | VENDOR[0]/RRH[0] |
| fail | | | | |
| rrh | Major | 2022 May 25 | 2022 May 25 | RACK[0]/SHELF[0]/SLOT[1]- |
| communication- | | 0:27 | 0:34 | VENDOR[0]/RRH[1] |
| fail | | | | |
| . . . | . . . | . . . | . . . | . . . |
| ecp optic- | Major | 2022 May 25 | 2022 May 25 | RACK[0]/SHELF[0]/SLOT[1]- |
| transceiver-rx-los | | 0:54 | 0:56 | ECP[0]/CPRI_PORT[0] |
| rrh | Major | 2022 May 25 | 2022 May 25 | RACK[0]/SHELF[0]/SLOT[1]- |
| communication- | | 0:56 | 0:57 | VENDO0R[0]/RRH[2] |
| fail | | | | |
| Service-off | Critical | 2022 May 25 | 2022 May 25 | NBIOT[ ] |
| | | 0:57 | 0:57 | |
| ecp optic- | Major | 2022 May 25 | 2022 May 25 | RACK[0]/SHELF[0]/SLOT[2]- |
| transceiver-rx-los | | 1:32 | 1:34 | ECP[1]/CPRI_PORT[0] |
| . . . | . . . | . . . | . . . | . . . |

In Table 4, a ‘PROBABLE CAUSE’ field means a name of the alarm. A ‘severity’ field means severity of the alarm. An ‘occur time’ field means a time when the alarm starts. A ‘clear time’ field means a time when the alarm ends. A ‘location’ field means a location (or point) where the alarm has occurred. The data configured as shown in Table 4 may be related to the data 910 of FIG. 9A.

The electronic device 500 may identify a graph indicating a change of the KPI according to a time. For example, the KPI may be set as ‘RRC Restatement Rate’. The graph 1110 indicates a change of ‘RRC Restatement Rate’ according to a time. A horizontal axis of the graph 1110 indicates a time (or date). A vertical axis of the graph 1110 indicates a value (unit: percent (%)) for ‘RRC Restatement Rate’.

The electronic device 500 may identify a graph indicating an occurrence of at least one alarm according to a time based on the data on the alarm occurrence according to a time. For example, a graph 1120 may indicate whether an alarm 1 to an alarm n occur according to a time. A horizontal axis of the graph 1120 indicates a time (or date). A vertical axis of the graph 1120 indicates the alarm 1 to the alarm n. In the graph 1120, at least one block may be displayed based on a timing at which the alarm has occurred and a timing at which the alarm is terminated. For example, an object 1140 of the graph 1120 may indicate that an alarm 2 has been maintained from a timing 1141 to a timing 1142.

The electronic device 500 may identify an impacting alarm based on an association rule between a plurality of alarms (e.g., the alarm 1 to the alarm n) occurring in a time interval 1131 and the KPI, and a time-series association between the plurality of alarms and the KPI. For example, the electronic device 500 may identify that a change of the KPI occurs according to an alarm 3 occurring in the time interval 1131. The electronic device 500 may identify the alarm 3 as the impacting alarm.

The electronic device 500 may display the graph 1110 and the graph 1120 describe above through a display of the electronic device 500 and/or a display connected to the electronic device 500. The electronic device 500 may highlight a time interval (e.g., the time interval 1131) in which the anomaly of the KPI has occurred. In FIG. 11, the graph 1110 and the graph 1120 are illustrated, respectively, but the graph 1110 and the graph 1120 may be displayed together.

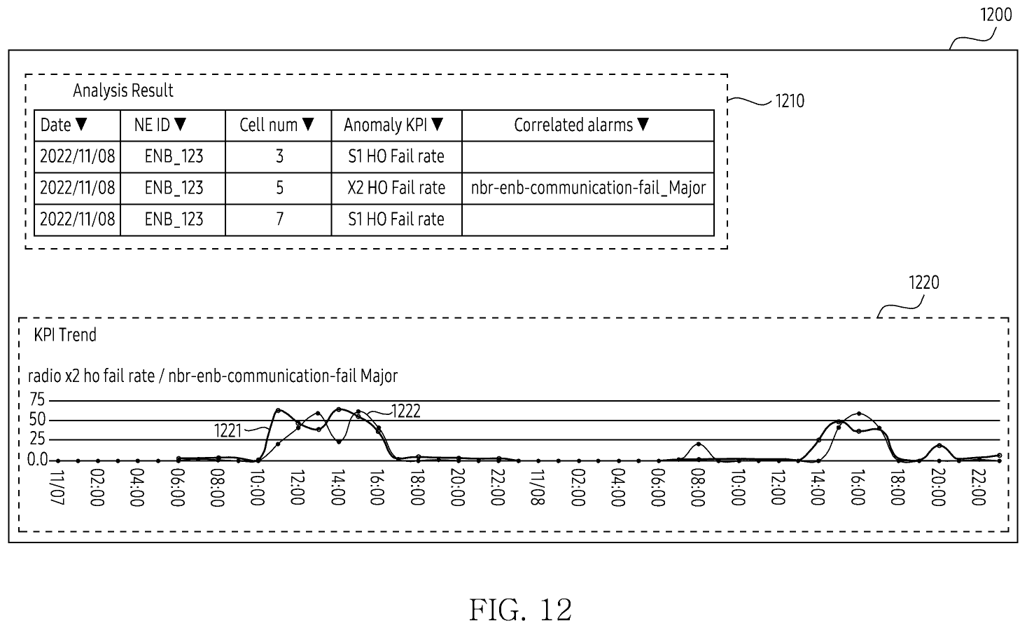

FIG. 12 illustrates an interface for displaying a graph indicating a change of KPI according to an alarm according to an embodiment of the disclosure.

Referring to FIG. 12, an electronic device 500 may display an interface 1200 through a display. The interface 1200 may include a region 1210 for displaying data on an anomaly of KPI according to a time and an occurring alarm, and a region 1220 for displaying a change of the KPI according to a time and an alarm occurrence rate. For example, the electronic device 500 may display, in the region 1210, a table indicating information on the anomaly of the KPI related to a cell for NE and an alarm related to the anomaly of the KPI according to a date (e.g., Nov. 8, 2022). The electronic device 500 may display, in the region 1220, a graph 1221 indicating the change of KPI (e.g., ‘radio x2 ho fail rate’) according to a time and a graph 1222 indicating an occurrence rate (e.g., ‘nbr-enb-communication-fail Major’) of the alarm according to a time.

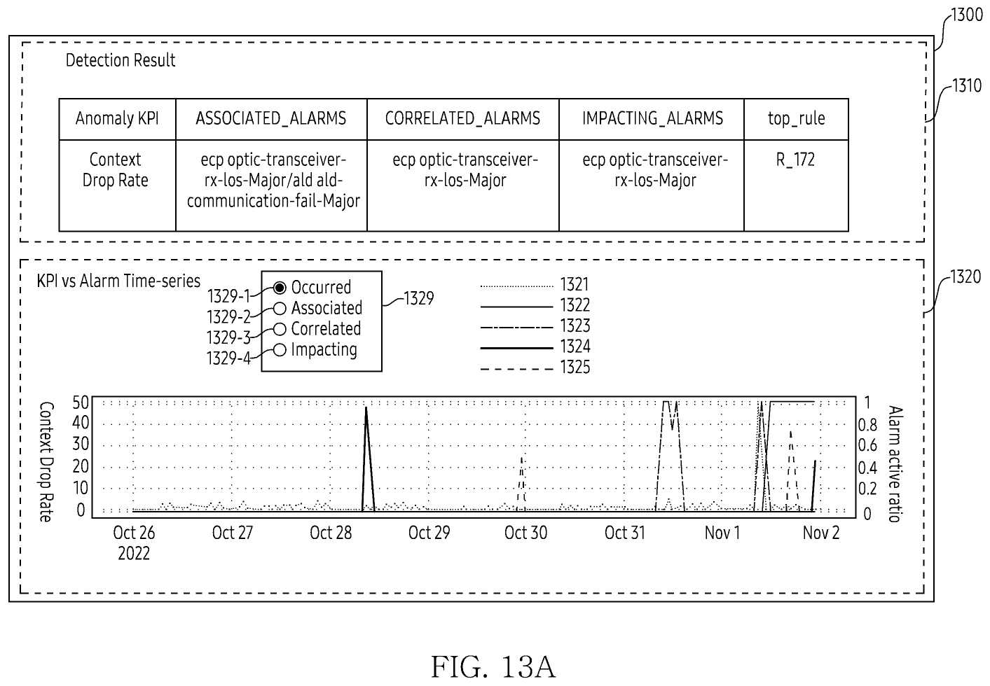

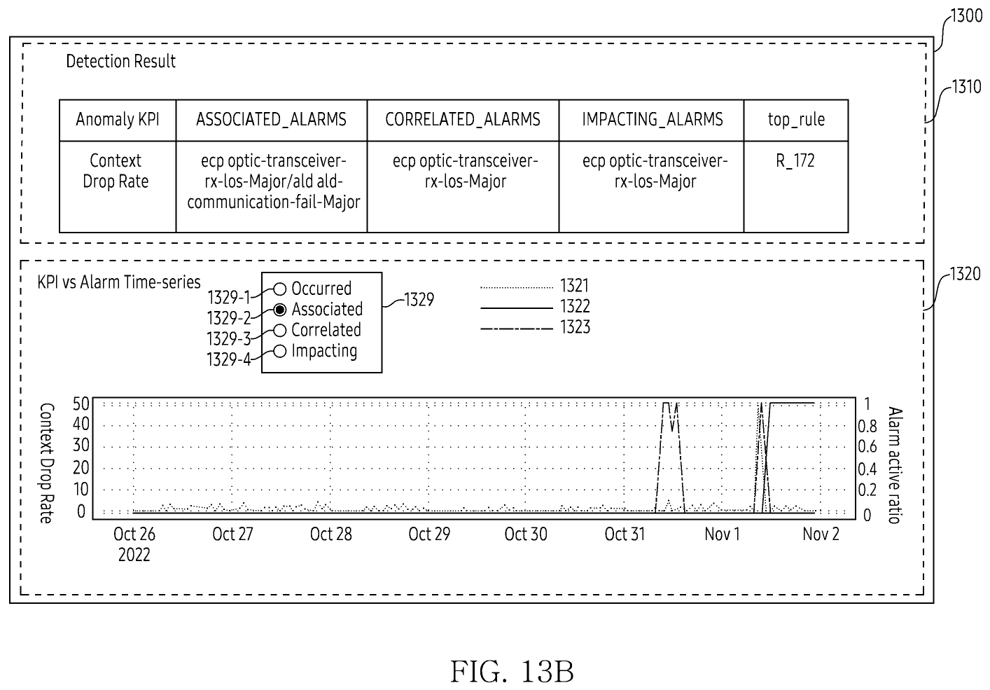

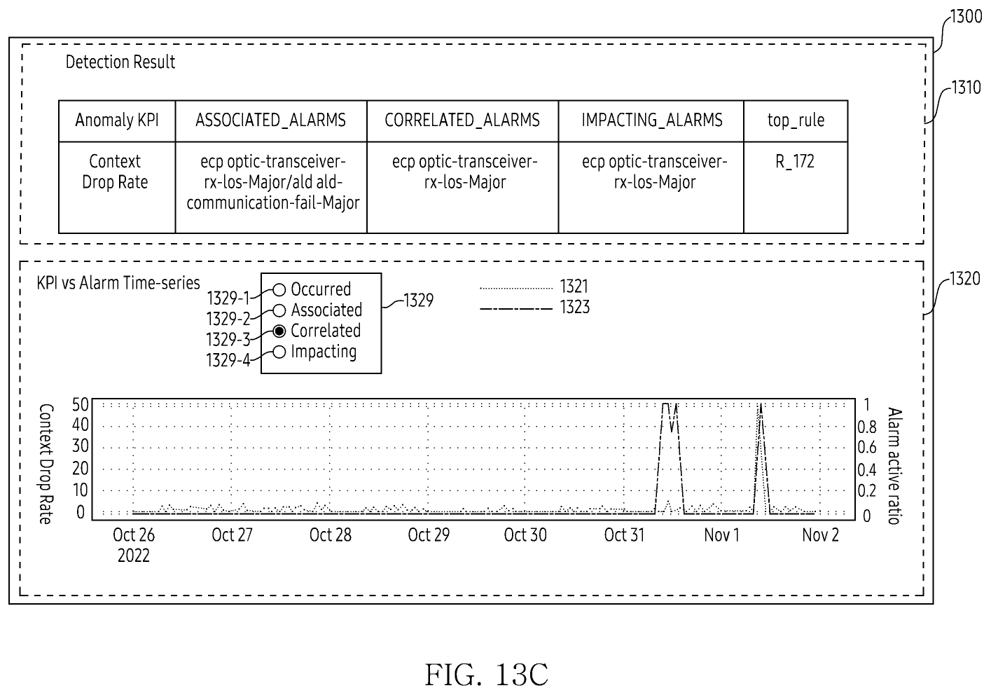

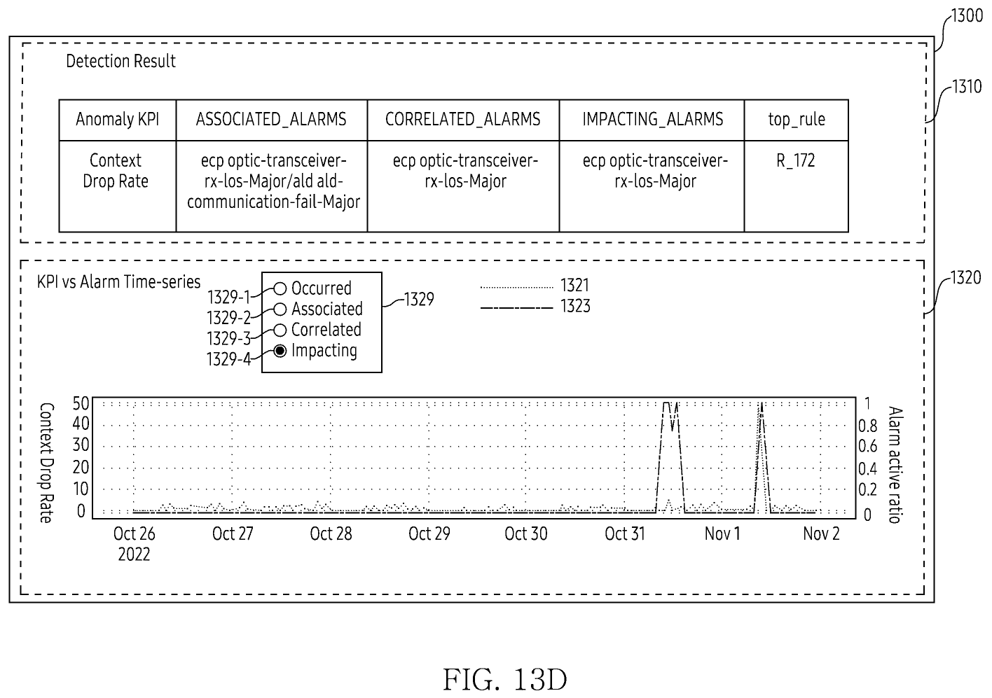

The electronic device 500 may visualize an alarm related to the anomaly (or a deterioration of the KPI) of the KPI in a time-series together with the KPI, and display the visualized alarm and KPI through a graphical user interface (GUI). An operation of the electronic device for displaying candidate alarms related to the deterioration of the KPI will be described in FIGS. 13A, 13B, 13C, and 13D.

FIGS. 13A, 13B, 13C, and 13D illustrate an example of an interface for displaying a portion of candidate alarms related to a deterioration of KPI according to various embodiments of the disclosure.

Referring to FIGS. 13A, 13B, 13C, and 13D, an electronic device 500 may display an interface 1300 through a display. The interface 1300 may include a region 1310 for displaying information on candidate alarms and an impacting alarm identified among the candidate alarms, and a region 1320 for displaying a portion of the candidate alarms according to a designated antecedent among the candidate alarms.

The electronic device 500 may display, in the region 1310, the information on the candidate alarms and the impacting alarm identified among the candidate alarms. The electronic device 500 may display, in the region 1310, a table indicating information on an anomaly of the KPI occurring in NE, information on the candidate alarms, and information on the impacting alarm. An ‘Anomaly KPI’ field indicates the KPI in which the anomaly has occurred. An ‘ASSOCIATED_ALARMS’ field indicates at least one alarm (or a first candidate alarm group) identified according to an association antecedent among the candidate alarms. A ‘CORELATED_ALARMS’ field indicates at least one alarm (or a second candidate alarm group) identified according to a time-series correlation among the candidate alarms. An ‘IMPACTING_ALARMS’ field indicates an impacting alarm identified as a cause of the anomaly of the KPI among the candidate alarms. A ‘top_rule’ field indicates a matched association antecedent. Although not illustrated, the electronic device 500 may display information on the matched association antecedent on the interface 1300. For example, the electronic device 500 may display the information on the matched association antecedent using a table configured as shown in Table 2.

The electronic device 500 may display an object 1329 in the region 1320. The object 1329 may be used to select a portion of the candidate alarms displayed in the region 1320. For example, the object 1329 may include a visual object 1329-1 to a visual object 1329-4. A portion of the candidate alarms related to each visual object may be displayed in the region 1320. For example, the visual object 1329-1 may be referred to as an ‘Occurred’ tab. The visual object 1329-2 may be referred to as an ‘Associated’ tab. The visual object 1329-3 may be referred to as a ‘Correlated’ tab. The visual object 1329-4 may be referred to as an ‘Impacting’ tab. FIGS. 13A, 13B, 13C, and 13D illustrate an example of displaying a graph of the candidate alarms according to an input for each visual object.

Referring to FIG. 13A, the electronic device 500 may identify an input for the visual object 1329-1 in the object 1329. The electronic device 500 may display an alarm occurrence rate of all candidate alarms occurring along with the deterioration of the KPI according to a time based on an input for the visual object 1329-1 (or the ‘Occurred’ tab). For example, the electronic device 500 may identify a first alarm to a fourth alarm as all candidate alarms occurring along with the deterioration of the KPI (e.g., ‘PREPOST_CONTEXT_DROP_RATE’) according to a time.

A graph 1321 indicates a change of the KPI (e.g., ‘PREPOST_CONTEXT_DROP_RATE’) according to a time. A horizontal axis of the graph 1321 indicates according to a time. A vertical axis (left) of the graph 1321 indicates a value (unit: %) for the KPI.

A graph 1322 indicates an alarm occurrence rate of the first alarm (e.g., ‘aldald-communication-fail_Major’) according to a time. A graph 1323 indicates an alarm occurrence rate of the second alarm (e.g., ‘ecoptic-transceiver-rx-los_Major’) according to a time. A graph 1324 indicates an alarm occurrence rate of the third alarm (e.g., ‘nbr-enb-communication-fail_Major’) according to a time. A graph 1325 indicates an alarm occurrence rate of the fourth alarm (e.g., ‘rhrssi-imbalance_Minor’) according to a time. A horizontal axis of the graph 1322 to the graph 1325 indicates a time. A vertical axis (right) of the graph 1322 to the graph 1325 indicates an alarm occurrence rate.

Referring to FIG. 13B, the electronic device 500 may identify an input for the visual object 1329-2 in the object 1329. The electronic device 500 may display an alarm occurrence rate of a portion of the candidate alarms occurring along with the deterioration of the KPI according to a time, based on the input for the visual object 1329-2 (or the ‘Associated’ tab). The electronic device 500 may identify alarms (or the first candidate alarm group) identified based on a trained association rule. The electronic device 500 may identify the first alarm and the second alarm based on the trained association rule. The electronic device 500 may display the graph 1322 and the graph 1323 in the region 1320 together with the graph 1321 related to the KPI.

Referring to FIG. 13C, the electronic device 500 may identify the input for the visual object 1329-3 in the object 1329. The electronic device 500 may display the alarm occurrence rate of the portion of the candidate alarms occurring along with the deterioration of the KPI according to a time based on the input for the visual object 1329-3 (or a ‘Correlated’ tab). The electronic device 500 may identify alarms (or the second candidate alarm group) identified based on the time-series correlation. The electronic device 500 may identify the second alarm based on the time-series correlation. The electronic device 500 may display the graph 1323 related to the second alarm together with the graph 1321 related to the KPI in the region 1320.

Referring to FIG. 13D, the electronic device 500 may identify an input for the visual object 1329-4 in the object 1329. The electronic device 500 may display an alarm occurrence rate of the impacting alarm (or at least one impacting alarm) along with the deterioration of the KPI according to a time based on the input for the visual object 1329-4 (or the ‘Impacting’ tab). The electronic device 500 may identify the impacting alarm (or the at least one impacting alarm) identified based on the trained association rule and the time-series correlation. The electronic device 500 may identify the second alarm based on the trained association rule and the time-series correlation. The electronic device 500 may display the graph 1323 related to the second alarm together with the graph 1321 related to the KPI in the region 1320.

According to the above-described embodiment, the electronic device 500 may selectively visualize and display all alarms (or candidate alarms) occurring during a time interval in which the deterioration of the KPI (or the anomaly of the KPI) has occurred, at least one alarm matching the association rule, at least one alarm with a high time-series correlation, and finally determined cause alarm (or impacting alarm). The electronic device 500 may visualize and display alarms identified according to various antecedents so that a user may selectively refer to an analysis result.

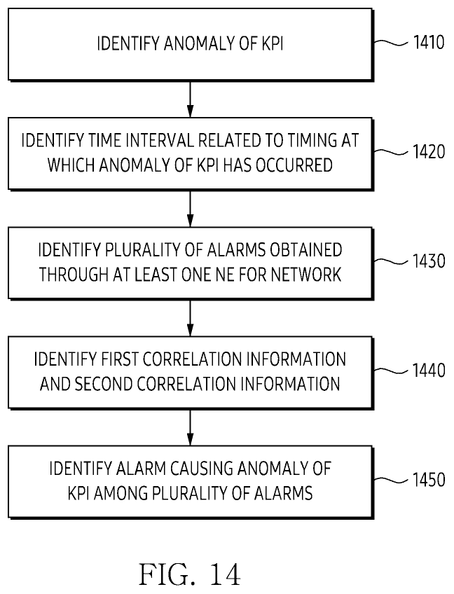

FIG. 14 illustrates a flowchart with respect to an operation of an electronic device according to an embodiment of the disclosure. Operations 1410 to 1450 of FIG. 14 may be performed by a processor of an electronic device 500.

In the following embodiment, each operation may be performed sequentially, but is not necessarily performed sequentially. For example, an order of each operation may be changed, and at least two operations may be performed in parallel.

In operation 1410, the electronic device 500 may identify an anomaly of KPI. For example, the electronic device 500 may identify the anomaly of the KPI based on a value for the KPI related to quality of a network being out of a designated range.

For example, the electronic device 500 may monitor the value for the KPI. While monitoring the value for the KPI, the electronic device 500 may identify that the value for the KPI is out of the designated range. The electronic device 500 may identify the anomaly of the KPI based on the value for the KPI being out of the designated range.

In operation 1420, the electronic device 500 may identify a time interval related to a timing at which the anomaly of the KPI has occurred. For example, the electronic device 500 may identify a first timing before a first time interval from the timing at which the anomaly of the KPI is found. The electronic device 500 may identify a second timing after a second time interval from the timing at which the anomaly of the KPI is found. The electronic device 500 may identify a time interval from the first timing to the second timing as the time interval related to the timing at which the anomaly of the KPI has occurred. The first time interval and the second time interval may be set to be the same.

In operation 1430, the electronic device 500 may identify a plurality of alarms obtained through at least one NE for the network. For example, the electronic device 500 may identify the plurality of alarms obtained through the at least one network element (NE) for the network in the identified time interval.

The electronic device 500 may receive an alarm from the at least one NE for the network related to the electronic device 500. The electronic device 500 may identify the plurality of alarms obtained in the identified time interval from the at least one NE. The electronic device 500 may identify the plurality of identified alarms as candidate alarms causing the anomaly of the KPI.

In operation 1440, the electronic device 500 may identify first correlation information and second correlation information. For example, the electronic device 500 may identify the first correlation information between the KPI and the plurality of alarms identified using the trained data on the KPI, and the second correlation information between the KPI and the plurality of alarms identified according to the timing at which the anomaly of the KPI is found and occurrence timings of the plurality of alarms.

The electronic device 500 may identify a first candidate alarm set by using the plurality of alarms based on the first correlation information. The electronic device 500 may configure alarms identified based on the first correlation information among the plurality of alarms as the first candidate alarm set. The electronic device 500 may identify a second candidate alarm set by using the plurality of alarms based on the second correlation information. The electronic device 500 may configure alarms identified based on the second correlation information among the plurality of alarms as the second candidate alarm set.

For example, the electronic device 500 may identify the first correlation information between the KPI and the plurality of alarms using the trained data on the KPI. The electronic device 500 may identify at least one association rule between the KPI and the plurality of alarms using an association rule mining process. For example, the electronic device 500 may set information on the anomaly of the KPI, information on an occurrence of the plurality of alarms, and information on duration of the plurality of alarms as an input value of the association rule mining process. The electronic device 500 may identify at least one association rule as an output value of the association rule mining process. The electronic device 500 may set an antecedent field related to the at least one association rule as an item related to the anomaly of the KPI. The electronic device 500 may set a consequent field related to the at least one association rule as an item related to the plurality of alarms. The electronic device 500 may obtain the trained data on the KPI based on identifying the at least one association rule.

For example, the electronic device 500 may obtain the trained data on the KPI before the anomaly of the KPI occurs. The electronic device 500 may identify alarms related to the KPI. The electronic device 500 may train an association rule between an alarm related to the KPI and the KPI. The electronic device 500 may obtain the trained data on the KPI based on training the association rule between the alarm related to the KPI and the KPI. The electronic device 500 may identify the first correlation information between the KPI and the plurality of alarms based on the pre-obtained association rule.

For example, the electronic device 500 may identify the second correlation information between the KPI and the plurality of alarms based on the timing at which the anomaly of the KPI has occurred and the occurrence timings of the plurality of alarms. The electronic device 500 may identify the second correlation information between the KPI and the plurality of alarms according to the timing at which the anomaly of the KPI has occurred and the occurrence timings of the plurality of alarms.

For example, the electronic device 500 may identify a time-series correlation related to values for the KPI according to a time and values for an alarm occurrence rate of the first alarm among the plurality of alarms according to a time. The electronic device 500 may configure the first alarm as the second candidate alarm set based on identifying that a value for the time series correlation is within a threshold range. The electronic device 500 may configure a portion of the plurality of alarms as the second candidate alarm set through a method similar to the first alarm.

As an example, the electronic device 500 may identify the values for the alarm occurrence rate of the first alarm according to a time. The electronic device 500 may perform time movement of the values for the alarm occurrence rate of the first alarm according to a time. According to a time movement value of the values for the alarm occurrence rate of the first alarm, a correlation value of the values for the KPI and the value for the alarm occurrence rate of the first alarm may be changed. The electronic device 500 may identify a value at which the correlation value is maximized as the time-series correlation related to the values for the KPI according to a time and the values for the alarm occurrence rate of the first alarm among the plurality of alarms according to a time. The electronic device 500 may configure the first alarm as the second candidate alarm set based on identifying that the value for the time series-correlation is within the threshold range. The threshold range may be changed based on a type of the KPI. In a case that the type of the KPI is a first type, the alarm and the KPI may have a positive correlation. In a case that the type of the KPI is a second type, the alarm and the KPI may have a negative correlation. Based on the type of the KPI being the first type, the threshold range may be set as a range that is greater than or equal to a first threshold value. Based on the type of the KPI being the second type, the threshold range may be set as a range that is less than a second threshold value.

In operation 1450, the electronic device 500 may identify an alarm causing the anomaly of the KPI among the plurality of alarms. For example, the electronic device 500 may identify the alarm causing the anomaly of the KPI among the plurality of alarms based on the first correlation information and the second correlation information.

For example, the electronic device 500 may identify the alarm causing the anomaly of the KPI among the plurality of alarms based on the first candidate alarm set and the second candidate alarm set. The first candidate alarm set may be identified based on the first correlation. The second candidate alarm set may be identified based on the second correlation. The electronic device 500 may identify the first alarm included in both the first candidate alarm set and the second candidate alarm set as the alarm causing the anomaly of the KPI.

According to an embodiment, the electronic device 500 may display a graph of a change of the KPI according to a time and at least one graph of an alarm occurrence rate of at least a portion of the plurality of alarms according to a time by using a display (or a display connected to the electronic device 500) of the electronic device 500.

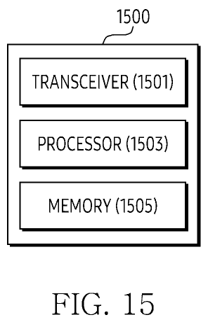

FIG. 15 illustrates an example of a functional configuration of an electronic device according to an embodiment of the disclosure.

Referring to FIG. 15, an electronic device 1500 may correspond to the electronic device 500 of FIGS. 5 to 8, 9A, 9B, 10A, 10B, 11, 12, 13A to 13D, and 14.

According to an embodiment, the electronic device 1500 may include a transceiver 1501, a processor 1503, and memory 1505.

The transceiver 1501 may perform functions for transmitting and receiving signals in a wired communication environment. The transceiver 1501 may include a wired interface for controlling a direct connection between a device-to-device through a transmission medium (e.g., a copper wire, or optical fiber). For example, the transceiver 1501 may transmit an electrical signal to another device through the copper wire or perform conversion between an electrical signal and an optical signal.

The transceiver 1501 may perform functions for transmitting and receiving signals in a wireless communication environment. For example, the transceiver 1501 may perform a conversion function between a baseband signal and a bit stream according to a physical layer standard of a system. For example, when transmitting data, the transceiver 1501 generates complex-valued symbols by encoding and modulating a transmission bit stream. In addition, when receiving data, the transceiver 1501 restores a reception bit stream by demodulating and decoding the baseband signal. Also, the transceiver 1501 may include a plurality of transmission/reception paths.

The transceiver 1501 transmits and receives signals as described above. Accordingly, all or part of the transceiver 1501 may be referred to as a ‘communication unit’, a ‘transmission unit’, a ‘reception unit’, or a ‘transmission/reception unit’. In addition, in the following description, transmission and reception performed through the wireless channel are used to mean including a process being performed as described above by the transceiver 1501.

The processor 1503 controls overall operations of the electronic device 1500. The processor 1503 may be referred to as a controller. For example, the processor 1503 transmits and receives signals through the transceiver 1501. In addition, the processor 1503 writes and reads data to and from the memory 1505. In addition, the processor 1503 may perform functions of a protocol stack required from a communication standard. Although only the processor 1503 is illustrated in FIG. 15, according to another implementation, the electronic device 1500 may include two or more processors.

In the disclosure, operations of the processor 1503 may mean being executed by software or controlling hardware components such as a Field Programmable Gate Array (FPGA) or an application-specific integrated circuit (ASIC). In addition, the processor 1503 may include at least one of software components, object-oriented software components, components such as class components and task components, processes, functions, attributes, procedures, subroutines, segments of program code, drivers, firmware, microcode, circuitry, data, database, data structures, tables, arrays, and variables. The processor 1503 may include at least one module, and a term “module” includes a unit configured with hardware, software, or firmware. For example, the module may be used interchangeably with terms such as logic, logical blocks, components, or circuits, and the like. The module may be an integrated component or a minimum unit performing one or more functions, or a part thereof. For example, the module may be configured with the ASIC.

For example, the processor 1503 may include at least some or all of the blocks illustrated in FIG. 4 or 5. The processor 1503 may perform functions of at least some or all of the blocks illustrated in FIG. 4 or 5.

The memory 1505 stores data such as a basic program, an application program, and setting information for an operation of the electronic device 1500. The memory 1505 may be referred to as a storage unit. The memory 1505 may be composed of volatile memory, non-volatile memory, or a combination of volatile memory and non-volatile memory. In addition, the memory 1505 provides the stored data according to a request of the processor 1503.

According to the above-described embodiments, an alarm (or an impacting alarm) causing an anomaly (or a deterioration of KPI) of the KPI of a network may be identified (or detected). In addition, an electronic device (e.g., the electronic device 500 or the electronic device 1500) according to the above-described embodiment may identify an alarm (or an impacting alarm) causing an anomaly of the KPI by considering both an association rule between the KPI and the alarm trained through past data using association rule mining and an identified time-series correlation.

According to the above-described embodiment, network quality may be improved by reducing human efficiency required for KPI deterioration/anomaly Site/Cell analysis and detecting a quick/accurate cause alarm.

According to the above-described embodiments, time/cost due to automation of analysis workflow for troubleshooting a network performance problem may be reduced.

According to the above-described embodiments, more accurate cause analysis may be possible by determining a cause alarm by considering both an actual phenomenon (a correlation during a corresponding interval) and an empirical probability for analysis target NE/Cell.

According to an embodiment, an application for analyzing an effect of the alarm related to the anomaly of the KPI and identifying the alarm causing the anomaly of the KPI may be displayed through the electronic device.

According to an embodiment, the electronic device may determine a set of candidate alarms capable of occurring more than at least one KPI.

For example, the electronic device may obtain time-series data for the candidate alarms by preprocessing data on the candidate alarms.

For example, the electronic device may obtain a time-series correlation between at least one KPI and the candidate alarms.

For example, the electronic device may detect (or judge) an alarm that is the cause of the anomaly of the KPI among the candidate alarms based on the time series-correlation between the at least one KPI and the candidate alarms.

For example, the electronic device may filter the candidate alarms using a relationship between the pre-trained alarm and KPI.

For example, an electronic device may identify (or detect) alarms with high time-series correlation (e.g., positive correlation) or low time-series correlation (e.g., negative correlation) based on a designated threshold value.

For example, electronic devices may identify (or detect) alarms with relatively high time-series correlation (e.g., positive correlation) or relatively low time-series correlation (e.g., negative correlation) based on trained time-series correlation statistics.

For example, the electronic device may identify (or analyze) the time-series correlation between the KPI and the alarm in a plurality of time intervals (e.g., a short-term time interval and a long-term time interval).

For example, when identifying the alarm (or the impacting alarm) that is the cause of the anomaly of the KPI, the electronic device may only identify (or detect) alarms with a predetermined sign (e.g., positive or negative) for each KPI. The electronic device 500 may identify the alarm that is the cause related to the anomaly of the KPI by identifying a correlation direction.

For example, the electronic device may display the alarm that is the cause related to the anomaly of the KPI, through GUI according to a time-series together with the KPI.

For example, the electronic device may display a time-series association between the alarm and the KPI that is the cause related to the anomaly of the KPI, through the GUI.

For example, the electronic device may display an association rule between the alarm and the KPI, through the GUI.

For example, the electronic device may display a record (i.e., raw data) of the alarm related to the alarm that is the cause related to the anomaly of the KPI, through the GUI.

According to an embodiment, the electronic device may train a relationship between an arbitrary alarm and KPI from past data.

For example, the electronic device may set whether the anomaly of the KPI occurs during a designated time window for each of at least one NE (or cell), whether the alarm occurs, the number of alarm occurrence, and duration of the alarm as an input value (or item) for training the association rule.

For example, the electronic device may train the association rule using the input values (or itemset) generated from the at least one NE (or cell).

For example, the electronic device may filter the identified (or extracted) association rule set so that an antecedent of the association rule includes only an item related to the anomaly of the KPI and a consequent of the association rule includes only an item related to the alarm.

For example, the electronic device may display the finally identified association rule through the GUI in a form of a table.

According to an embodiment, the electronic device may train (or analyze) the time-series correlation between the arbitrary alarm and KPI from past data.

For example, the electronic device may identify (or calculate) the time-series correlation between the alarm and the KPI for an arbitrary set of the KPI during a designated time interval related to alarms generated for each NE (or cell) related to a plurality of NEs (or cells).

For example, electronic devices may identify (or define) a correlation between the alarm and the KPI based on values (e.g., mean or median value) related to the time-series correlation between the statistically represented alarm and KPI and the designated threshold value.

For example, the electronic device may filter the identified (or extracted) association rule set so that the antecedent of the association rule includes only the item related to the anomaly of the KPI, and the consequent of the association rules includes only the item related to the alarm.

For example, the electronic device may display the finally identified association rule through the GUI in the form of the table.

According to the above-described embodiments, the cause alarm may be specified for an NE/Cell/interval in which the anomaly/deterioration of the KPI has occurred. According to the above-described embodiments, a statistical relationship (or the association rule) analysis method between the alarm and the KPI may be proposed. According to the above-described embodiments, an alarm-KPI time-series correlation analysis method for the NE/Cell/interval in which the anomaly/deterioration of the KPI has occurred may be proposed.

According to the above-described embodiments, accuracy of the cause alarm may be improved by detecting (specifying) the cause alarm related to the KPI in which the anomaly/deterioration has occurred based on a time-series correlation that has actually occurred as well as a statistical correlation. Since the electronic device provides a cause alarm detection result together with similarity of a temporal pattern of the KPI and the alarm, higher confidence may be provided for the result.

According to the above-described embodiments, since an antecedent (e.g., whether the alarm occurs, the number of times, and duration) for alarm generation characteristics related to the anomaly/deterioration of the KPI are configured in more detail, accuracy of cause alarm detection for the anomaly/deterioration of the KPI may be increased.

According to the above-described embodiments, the cause alarm may be specified through the alarm-KPI time-series correlation related to the KPI anomaly/deterioration NE/Cell/interval as well as the statistical correlation between the alarm—the KPI.

The effects that can be obtained from the disclosure are not limited to those described above, and any other effects not mentioned herein will be clearly understood by those having ordinary knowledge in the art to which the disclosure belongs, from the following description.

According to an embodiment, a method for an electronic device may comprise identifying, based on a value for a key performance indicator (KPI) related to quality of a network being out of a designated range, an anomaly of the KPI. The method may comprise identifying a time interval related to a timing in which the anomaly of the KPI has occurred. The method may comprise identifying, in the time interval, a plurality of alarms obtained through at least one network element (NE) for the network. The method may comprise identifying first correlation information between the KPI and the plurality of alarms identified using trained data related to the KPI and second correlation information between the KPI and the plurality of alarms identified according to the timing and occurrence timings of the plurality of alarms. The method may comprise identifying, based on the first correlation information and the second correlation information, an alarm causing the anomaly of the KPI among the plurality of alarms.

According to an embodiment, the method may comprise monitoring the value for the KPI. The method may comprise, while monitoring the value for the KPI, identifying that the value for the KPI is out of the designated range.

According to an embodiment, the method may comprise identifying, using the plurality of alarms, a first candidate alarm set based on the first correlation information. The method may comprise identifying, using the plurality of alarms, a second candidate alarm set based on the second correlation information. The method may comprise identifying the alarm causing the anomaly of the KPI among the plurality of alarms, based on the first candidate alarm set and the second candidate alarm set.

According to an embodiment, the method may comprise identifying a first alarm included in both the first candidate alarm set and the second candidate alarm set, as the alarm causing the anomaly of the KPI.

According to an embodiment, the method may comprise identifying a time-series correlation between values for the KPI according to a time and values for an alarm occurrence rate of the first alarm among the plurality of alarms. The method may comprise configuring, based on identifying that a value related to the time-series correlation is within a threshold range, the first alarm as the second candidate alarm set.

According to an embodiment, the threshold range may be set as a range that is greater than or equal to a first threshold value, based on a type of the KPI being a first type. The threshold range may be set as a range that is less than a second threshold value, based on a type of the KPI being a second type.

According to an embodiment, the method may comprise identifying, using an association rule mining process, at least one association rule between the KPI and the plurality of alarms. The method may comprise obtaining the trained data related to the KPI based on identifying the at least one association rule.

According to an embodiment, the method may comprise setting information on the anomaly of the KPI, information on an occurrence of the plurality of alarms, and information on duration of the plurality of alarms as an input value of the association rule mining process.

According to an embodiment, the method may comprise setting an antecedent field related to the at least one association rule as an item related to the anomaly of the KPI. The method may comprise setting a consequent field related to the at least one association rule as an item related to the plurality of alarms.

According to an embodiment, the method may comprise displaying, using a display of the electronic device, a graph related to a change of the KPI according to a time and at least one graph related to an alarm occurrence rate of at least part of the plurality of the alarms according a time.

According to an embodiment, the method may comprise identifying at least one correlation between the KPI and the plurality of alarms using statistical hypothesis testing. The method may comprise, based on identifying the at least one correlation, obtaining the trained data related to the KPI.

According to an embodiment, an electronic device may comprise memory, a transceiver, and at least one processor. The at least one processor may be configured to identify, based on a value for a key performance indicator (KPI) related to quality of a network being out of a designated range, an anomaly of the KPI. The at least one processor may be configured to identify a time interval related to a timing in which the anomaly of the KPI has occurred. The at least one processor may be set to identify, in the time interval, a plurality of alarms obtained through at least one network element (NE) for the network. The at least one processor may be configured to identify first correlation information between the KPI and the plurality of alarms identified using trained data related to the KPI and second correlation information between the KPI and the plurality of alarms identified according to the timing and occurrence timings of the plurality of alarms. The at least one processor may be configured to identify, based on the first correlation information and the second correlation information, an alarm causing the anomaly of the KPI among the plurality of alarms.

According to an embodiment, the at least one processor may be configured to monitor the value for the KPI. The at least one processor may be configured to, while monitoring the value for the KPI, identify that the value for the KPI is out of the designated range.

According to an embodiment, the at least one processor may be configured to identify, using the plurality of alarms, a first candidate alarm set based on the first correlation information. The at least one processor may be configured to identify, using the plurality of alarms, a second candidate alarm set based on the second correlation information. The at least one processor may be configured to identify the alarm causing the anomaly of the KPI among the plurality of alarms, based on the first candidate alarm set and the second candidate alarm set.

According to an embodiment, the at least one processor may be configured to identify a first alarm included in both the first candidate alarm set and the second candidate alarm set, as the alarm causing the anomaly of the KPI.

According to an embodiment, the at least one processor may be configured to identify a time-series correlation between values for the KPI according to a time and values for an alarm occurrence rate of the first alarm among the plurality of alarms. The at least one processor may be configured to configure, based on identifying that a value related to the time-series correlation is within a threshold range, the first alarm as the second candidate alarm set.

According to an embodiment, the threshold range may be set as a range that is greater than or equal to a first threshold value, based on a type of the KPI being a first type. The threshold range may be set as a range that is less than a second threshold value, based on a type of the KPI being a second type.

According to an embodiment, the at least one processor may be configured to identify, using an association rule mining process, at least one association rule between the KPI and the plurality of alarms. The at least one processor may be configured to obtain the trained data related to the KPI based on identifying the at least one association rule.

According to an embodiment, the at least one processor may be configured to set information on the anomaly of the KPI, information on an occurrence of the plurality of alarms, and information on duration of the plurality of alarms as an input value of the association rule mining process.

According to an embodiment, the at least one processor may be configured to set an antecedent field related to the at least one association rule as an item related to the anomaly of the KPI. The at least one processor may be configured to set a consequent field related to the at least one association rule as an item related to the plurality of alarms.

According to an embodiment, the electronic device may comprise a display. The at least one processor may be configured to display, using the display, a graph related to a change of the KPI according to a time and at least one graph related to an alarm occurrence rate of at least part of the plurality of the alarms according a time.

According to an embodiment, the at least one processor may be configured to identify at least one correlation between the KPI and the plurality of alarms using statistical hypothesis testing. The at least one processor may be configured to, based on identifying the at least one correlation, obtain the trained data related to the KPI.

According to an embodiment, a non-transitory computer readable storage medium may comprise memory that stores a program including instructions. The instructions, when the instructions are executed by a processor, may cause the instructions to perform one of methods performed by an electronic device described above.

According to an embodiment, a non-transitory computer readable storage medium may store one or more programs. The one or more programs may comprise instructions which, when executed by a processor of an electronic device, cause the electronic device to identify, based on a value for a key performance indicator (KPI) related to quality of a network being out of a designated range, an anomaly of the KPI. The one or more programs may comprise instructions which, when executed by the processor of the electronic device, cause the electronic device to identify a time interval related to a timing in which the anomaly of the KPI has occurred. The one or more programs may comprise instructions which, when executed by the processor of the electronic device, cause the electronic device to identify, in the time interval, a plurality of alarms obtained through at least one network element (NE) for the network. The one or more programs may comprise instructions which, when executed by the processor of the electronic device, cause the electronic device to identify first correlation information between the KPI and the plurality of alarms identified using trained data related to the KPI and second correlation information between the KPI and the plurality of alarms identified according to the timing and occurrence timings of the plurality of alarms. The one or more programs may comprise instructions which, when executed by the processor of the electronic device, cause the electronic device to identify, based on the first correlation information and the second correlation information, an alarm causing the anomaly of the KPI among the plurality of alarms.

Methods according to embodiments described in claims or specifications of the disclosure may be implemented as a form of hardware, software, or a combination of hardware and software.

In a case of implementing as software, a computer-readable storage medium for storing one or more programs (software module) may be provided. The one or more programs stored in the computer-readable storage medium are configured for execution by one or more processors in an electronic device. The one or more programs include instructions that cause the electronic device to execute the methods according to embodiments described in claims or specifications of the disclosure. The one or more programs may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. In the case of being distributed online, at least part of the computer program product may be temporarily generated or at least temporarily stored in the machine-readable storage medium, such as memory of the manufacturer's server, the application store's server, or a relay server.

Such a program (software module, software) may be stored in random access memory, non-volatile memory including flash memory, read only memory (ROM), electrically erasable programmable read only memory (EEPROM), a magnetic disc storage device, a compact disc-ROM (CD-ROM), an optical storage device (digital versatile discs (DVDs) or other formats), or a magnetic cassette. Alternatively, it may be stored in memory configured with a combination of some or all of them. In addition, a plurality of configuration memories may be included.

Additionally, a program may be stored in an attachable storage device that may be accessed through a communication network such as the Internet, Intranet, local area network (LAN), wide area network (WAN), or storage area network (SAN), or a combination thereof. Such a storage device may be connected to a device performing an embodiment of the disclosure through an external port. In addition, a separate storage device on the communication network may also be connected to a device performing an embodiment of the disclosure.

In the above-described specific embodiments of the disclosure, components included in the disclosure are expressed in the singular or plural according to the presented specific embodiment. However, the singular or plural expression is selected appropriately according to a situation presented for convenience of explanation, and the disclosure is not limited to the singular or plural component, and even components expressed in the plural may be configured in the singular, or a component expressed in the singular may be configured in the plural.

According to various embodiments, one or more components or operations of the above-described components may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be executed sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by an electronic device, comprising:
identifying, based on a value for a key performance indicator (KPI) related to quality of a network being out of a designated range, an anomaly of the KPI;
identifying a time interval related to a timing in which the anomaly of the KPI has occurred;
identifying, in the time interval, a plurality of alarms obtained through at least one network element (NE) for the network;
identifying first correlation information between the KPI and the plurality of alarms identified using trained data related to the KPI and second correlation information between the KPI and the plurality of alarms identified according to the timing and occurrence timings of the plurality of alarms; and
identifying, based on the first correlation information and the second correlation information, an alarm causing the anomaly of the KPI among the plurality of alarms.

2. The method of claim 1, wherein the method further comprises:
monitoring the value for the KPI; and
while monitoring the value for the KPI, identifying that the value for the KPI is out of the designated range.

3. The method of claim 1, wherein the method further comprises:
identifying, using the plurality of alarms, a first candidate alarm set based on the first correlation information;
identifying, using the plurality of alarms, a second candidate alarm set based on the second correlation information; and
identifying the alarm causing the anomaly of the KPI among the plurality of alarms, based on the first candidate alarm set and the second candidate alarm set.

4. The method of claim 3, wherein the method further comprises:
identifying a first alarm included in both the first candidate alarm set and the second candidate alarm set, as the alarm causing the anomaly of the KPI.

5. The method of claim 4, wherein the method further comprises:
identifying a time-series correlation between values for the KPI according to a time and values for an alarm occurrence rate of the first alarm among the plurality of alarms; and
configuring, based on identifying that a value related to the time-series correlation is within a threshold range, the first alarm as the second candidate alarm set.

6. The method of claim 5, wherein the threshold range is set as a range that is greater than or equal to a first threshold value, based on a type of the KPI being a first type, and
wherein the threshold range is set as a range that is less than a second threshold value, based on a type of the KPI being a second type.

7. The method of claim 1, wherein the method further comprises:
identifying, using an association rule mining process, at least one association rule between the KPI and the plurality of alarms; and
obtaining the trained data related to the KPI based on identifying the at least one association rule.

8. The method of claim 7, wherein the method further comprises:
setting information on the anomaly of the KPI, information on an occurrence of the plurality of alarms, and information on duration of the plurality of alarms as an input value of the association rule mining process.

9. The method of claim 8, wherein the method further comprises:
setting an antecedent field related to the at least one association rule as an item related to the anomaly of the KPI; and
setting a consequent field related to the at least one association rule as an item related to the plurality of alarms.

10. The method of claim 1, wherein the method further comprises:
displaying, using a display of the electronic device, a graph related to a change of the KPI according to a time and at least one graph related to an alarm occurrence rate of at least part of the plurality of the alarms according a time.

11. The method of claim 1, wherein the method further comprises:
identifying at least one correlation between the KPI and the plurality of alarms using statistical hypothesis testing; and
based on identifying the at least one correlation, obtaining the trained data related to the KPI.

12. An electronic device comprising:
memory, comprising one or more storage media, storing instructions;
a transceiver; and
one or more processors communicatively coupled to the transceiver and the memory,
wherein the instructions, when executed by the one or more processors individually or collectively, cause the electronic device to:
identify, based on a value for a key performance indicator (KPI) related to quality of a network being out of a designated range, an anomaly of the KPI,
identify a time interval related to a timing in which the anomaly of the KPI has occurred,
identify, in the time interval, a plurality of alarms obtained through at least one network element (NE) for the network,
identify first correlation information between the KPI and the plurality of alarms identified using trained data related to the KPI and second correlation information between the KPI and the plurality of alarms identified according to the timing and occurrence timings of the plurality of alarms, and
identify, based on the first correlation information and the second correlation information, an alarm causing the anomaly of the KPI among the plurality of alarms.

13. The electronic device of claim 12, wherein the instructions, when executed by one or more processors individually or collectively, further cause the electronic device to:
monitor the value for the KPI; and
while monitoring the value for the KPI, identify that the value for the KPI is out of the designated range.

14. The electronic device of claim 12, wherein the instructions, when executed by one or more processors individually or collectively, further cause the electronic device to:
identify, using the plurality of alarms, a first candidate alarm set based on the first correlation information;
identify, using the plurality of alarms, a second candidate alarm set based on the second correlation information; and
identify the alarm causing the anomaly of the KPI among the plurality of alarms, based on the first candidate alarm set and the second candidate alarm set.

15. One or more non-transitory computer-readable storage media storing one or more computer programs, wherein the one or more computer programs include computer-executable instructions that, when executed by one or more processors of an electronic device individually or collectively, cause the electronic device to perform operations, the operations comprising:
identifying, based on a value for a key performance indicator (KPI) related to quality of a network being out of a designated range, an anomaly of the KPI;
identifying a time interval related to a timing in which the anomaly of the KPI has occurred;
identifying, in the time interval, a plurality of alarms obtained through at least one network element (NE) for the network;
identifying first correlation information between the KPI and the plurality of alarms identified using trained data related to the KPI and second correlation information between the KPI and the plurality of alarms identified according to the timing and occurrence timings of the plurality of alarms; and
identifying, based on the first correlation information and the second correlation information, an alarm causing the anomaly of the KPI among the plurality of alarms.

16. The one or more non-transitory computer-readable storage media of claim 15, the operations further comprising:
monitoring the value for the KPI; and
while monitoring the value for the KPI, identifying that the value for the KPI is out of the designated range.

17. The one or more non-transitory computer-readable storage media of claim 15, the operations further comprising:
identifying, using the plurality of alarms, a first candidate alarm set based on the first correlation information;
identifying, using the plurality of alarms, a second candidate alarm set based on the second correlation information; and
identifying the alarm causing the anomaly of the KPI among the plurality of alarms, based on the first candidate alarm set and the second candidate alarm set.

18. The one or more non-transitory computer-readable storage media of claim 17, the operations further comprising:
identifying a first alarm included in both the first candidate alarm set and the second candidate alarm set, as the alarm causing the anomaly of the KPI.

19. The one or more non-transitory computer-readable storage media of claim 18, the operations further comprising:
identifying a time-series correlation between values for the KPI according to a time and values for an alarm occurrence rate of the first alarm among the plurality of alarms; and
configuring, based on identifying that a value related to the time-series correlation is within a threshold range, the first alarm as the second candidate alarm set.

20. The one or more non-transitory computer-readable storage media of claim 19,
wherein the threshold range is set as a range that is greater than or equal to a first threshold value, based on a type of the KPI being a first type, and
wherein the threshold range is set as a range that is less than a second threshold value, based on a type of the KPI being a second type.
